(19) United States
(12) Patent Application Publication
(10) Pub. No.: US 2025/0225774 A1
(43) Pub. Date: Jul. 10, 2025

(54) SYSTEM FOR VEHICLE AXLE COUNT USING VISION

(71) Applicant: Oracle International Corporation, Redwood Shores, CA (US)

(72) Inventors: Sandeep Jana, Bengaluru (IN); Sourabh Singh Yadav, Bengaluru (IN); Avinash Rajeshchandra Rai, Bengaluru (IN); Kulbhushan Pachauri, Bangalore (IN)

(73) Assignee: Oracle International Corporation, Redwood Shores, CA (US)

(21) Appl. No.: 19/008,384

(22) Filed: Jan. 2, 2025

Related U.S. Application Data
(60) Provisional application No. 63/618,173, filed on Jan. 5, 2024.

(51) Int. Cl. G06V 10/776; G06T 7/215; G06T 7/73; G06V 10/26; G06V 10/764; G06V 20/54

(52) U.S. Cl. CPC G06V 10/776; G06T 7/215; G06T 7/74; G06V 10/26; G06V 10/764; G06V 20/54; G06T 2207/10016; G06T 2207/20081; G06T 2207/30236; G06T 2207/30242; G06V 2201/08

(57) ABSTRACT

A method may include receiving a first series of frames of image data may include a representation of a vehicle. The method may include for each frame of the first series of frames of the image data, identifying a wheel based at least in part on at least a portion of the frame of the image data. The method may include determining a set of coordinates indicating a position of the wheel within the frame of the image data. The method may include generating a graph based at least in part on the set of coordinates indicating the position of each wheel identified in each frame of the first series of frames of the image data. The method may include determining whether the wheel is associated with the vehicle. The method may include generating an axle count of the vehicle.

### CROSS-REFERENCES TO RELATED APPLICATIONS

This application is a non-provisional of and claims the benefit and priority under 35 U.S.C. 119(e) of U.S. Provisional Application No. 63/618,173, titled “SYSTEM FOR VEHICLE AXLE COUNT USING VISION,” filed on Jan. 5, 2024, which is incorporated herein by reference in its entirety for all purposes.

### BACKGROUND

Tolls for vehicles may be based on the number of axles a vehicle has. This is because vehicles wear a road surface simply by using the road. The heavier the vehicle (i.e., the more axles the vehicle has), the more wear on the road surface. Accurately determining a number of axles on a vehicle may be dependent on camera angle and sensitive to false positives and false negatives. Thus, improved systems and techniques for generating an axle count are needed.

### BRIEF SUMMARY

A method may include receiving, by a computing system, a first series of frames of image data may include a representation of a vehicle. The method may include for each frame of the first series of frames of the image data, identifying, by the computing system, a wheel based at least in part on at least a portion of the frame of the image data. The method may include determining, by the computing system, a set of coordinates indicating a position of the wheel within the frame of the image data. The method may include generating, by the computing system, a graph based at least in part on the set of coordinates indicating the position of each wheel identified in each frame of the first series of frames of the image data. The method may include determining, by the computing system, whether the wheel is associated with the vehicle. The method may include generating, by the computing system, an axle count of the vehicle.

In some embodiments, the method may include receiving, by the computing system, a second series of frames of image data may include a representation of a portion of the vehicle. The method may include determining, by the computing system, that the portion of the vehicle represented in the second series of frames is associated with the vehicle. The method may include associating, by the computing system, the portion of the vehicle with the vehicle represented in the first series of frames.

In some embodiments, the method may include generating, by the computing system, a bounding box about a portion of each frame of the first series of frames. The method may include identifying, by the computing system, a plurality of wheels in each of the first series of frames of image data. The method may include determining, by the computing system, a first subset of the plurality of wheels may include one or more wheels inside the bounding box and a second subset of the plurality of wheels outside the bounding box. The method may include retaining, by the computing system, the first subset of the plurality of wheels for further processing. A second subset of the plurality of wheels may be identified outside of the bounding box and may be excluded from further processing based at least in part on a position of each of the second subset of the plurality of wheels. The computing system may determine that the vehicle is within a region of interest. The data indicating the axle count may be used to verify a historical axle count associated with the vehicle. The wheel may be identified using a machine learning model trained exclusively on wheel data. The method may include providing, by the computing system, at least a portion of the first series of frames to a machine learning model. The method may include determining, by the computing system and using the machine learning model, a bounding box about the vehicle. The method may include determining, by the computing system and using the machine learning model, a vehicle-type of the vehicle and a confidence score associated with the vehicle type. The method may include determining, by the computing system, the axle count of the vehicle based at least in part on the vehicle-type of the vehicle.

A system may include one or more processors and a non-transitory computer readable medium including instructions that, when executed by the one or more processors, cause the system to perform operations. According to the operations, the system may receive a first series of frames of image data may include a representation of a vehicle. For each frame of the first series of frames of the image data, the system may identify a wheel based at least in part on at least a portion of the frame of image data, and determine a set of coordinates indicating a position of the wheel within the frame of image data. The system may generate a graph based at least in part on the set of coordinates indicating the position of each wheel identified in each frame of the first series of frames of image data. The system may determine whether the wheel is associated with the vehicle, based at least in part on the graph. Based at least in part on determining that the wheel is associated with the vehicle, the system may generate an axle count of the vehicle.

In some embodiments, system may include a first detector with a first machine learning model configured to identify the vehicle in the first series of frames of image data, determine a vehicle-type of the vehicle, and a confidence score associated with the vehicle-type. The system may include second detector with a second machine learning model configured to identify the wheel within a bounding box generated within the first series of frame of image data and a post-processing module configured to generate the axle count of the vehicle based at least in part on the wheel identified within the bounding box. A subset of the wheels identified in each frame identified outside of the bounding box may be excluded from further processing based at least in part on a position of each of the second subset of the plurality of wheels. The system may determine the vehicle is within a region of interest. The data indicating the axle count may be used to verify a historical axle count associated with the vehicle. The wheel may be identified using a machine learning model trained exclusively on wheel data.

A non-transitory computer readable-medium may include instructions that, when executed by one or more processors, cause the one or more processors to perform operations. The operations may include receiving, by a computing system, a first series of frames of image data may include a representation of a vehicle. The operations may include for each frame of the first series of frames of the image data, identifying, by the computing system, a wheel based at least in part on at least a portion of the frame of the image data. The operations may include determining, by the computing system, a set of coordinates indicating a position of the wheel within the frame of the image data. The operations may include generating, by the computing system, a graph based at least in part on the set of coordinates indicating the position of each wheel identified in each frame of the first series of frames of the image data. The operations may include determining, by the computing system, whether the wheel is associated with the vehicle. The operations may include generating, by the computing system, an axle count of the vehicle.

### BRIEF DESCRIPTION OF THE DRAWINGS

FIG. 1 illustrates a system and a process for generating an axle count for a vehicle, according to certain embodiments.

FIGS. 2A-2G illustrates a system for counting axles of a vehicle, according to certain embodiments.

FIG. 3 illustrates a flowchart of a method for generating an axle count, according to certain embodiments.

FIG. 4 is a block diagram illustrating one pattern for implementing a cloud infrastructure as a service system, according to at least one embodiment.

FIG. 5 is a block diagram illustrating another pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating an example computer system, according to at least one embodiment.

### DETAILED DESCRIPTION

Counting the number of axles of a vehicle is an important problem in toll and traffic management. Not only can axles be used as a proxy for a number of vehicles to be tolled, but to count the number of axles associated with each vehicle. Passenger cars, for example, typically have 2 axles. Large trucks can have any number of axles, particularly so when a trailer is attached to the truck. Vehicles with more axles may be heavier and cause more road damage. Toll rates may therefore be varied based on the number of axles a vehicle has in order to appropriately fund road repair. Accurately counting the axles of a vehicle is important for proper tolling, as well as to aid in traffic management, and enforce with laws and regulation (e.g., vehicle/weight restrictions).

Previously, toll booths were manned with people, who could count the number of axles of a vehicle and charge the driver appropriately while taking toll payment in cash. As payment methods changed to radio frequency identification (RFID) tags and other methods, fewer toll booths needed people to collect cash. Each RFID tag is associated with a vehicle, and the toll charge to a related account. In other words, the toll charged to an RFID tag is set when the account is created. This method may lead to problems, however. For example, an RFID tag may be associated with a 2-axle vehicle. On occasion, however, the vehicle may tow a trailer with at least one more axle. Then, the vehicle may only pay a toll for 2 axles instead of a different toll for three axles. In another example, the RFID tag may be moved to a different vehicle with more than 2 axles. The different vehicle may then be incorrectly tolled because the RFID is associated with the 2-axle vehicle.

Computer vision may be used to check that the toll charged to a vehicle based on an RFID tag (or other identifier) matches the number of axles actually present when the toll is levied. However, current computer vision techniques tend to utilize a single frame to identify an axle count. These techniques may have issues of their own. Using the vehicle towing a trailer example from above, the vehicle and trailer may not appear in the same frame. A wheel identifier (using computer vision) may not recognize that the trailer is associated with the vehicle, instead counting the vehicle and the trailer as two separate vehicles. Then, the vehicle may be charged because of the RFID tag associated therewith, while no toll may be assessed for the trailer, as there is not RFID associated.

In another example, current computer vision techniques may also overcharge tolls in some situations. A car carrier may include a semi-truck and trailer with a normal amount of axles (e.g., 5). However, the cars loaded onto the trailer may also have axles. The current techniques may then count each of the axles of each of the cars on the trailer and charge a toll based on the total number of axles instead of the correct amount (e.g., 5). Other problems with current axle count systems include the use of multiple cameras, angle of view limitations, frame count issues and others. Therefore, there is a need for improved axle vehicle counting systems and techniques via computer system.

One solution may be for a computing system to receive a consecutive series of frames from an optical sensor such as a video camera. The series of frames may be provided to a wheel detector (as tires may be a proxy for axles). For each of the frames, a first region of interest (ROI) may be identified in which the computing system may search for wheels. When the computing system identifies a wheel, a set of coordinates may be determined for the wheel. As the series of frames is consecutive, the coordinate of the wheel for each frame may change and the coordinates over time may be determined and a graph generated. Based on the graph, the wheel detector may determine an axle count for the series of frames.

At or near the same time, the same series of frames may be provided to a vehicle identifier. Using one or more machine learning models (MLMs), the vehicle detector may search for a vehicle within a second ROI. If, for example, a truck was towing a trailer, there may be one or more frames where a part of the truck and a part of the trailer are identified, and one or more frames where just the vehicle or just the trailer are identified. Put differently, the vehicle identifier may identify the truck and trailer as different vehicles based on the series of frames. The results of the vehicle identifier may be provided to a trailer identifier. The trailer identifier may then determine that the trailer is being towed by the truck and associate the trailer with the truck. Thus, the computing system may determine that the truck and trailer are actually one vehicle.

The results of the vehicle and trailer identifiers and the results of the wheel detector may then be provided to a post-processing unit. The post-processing unit may then associate the wheel count with the vehicle(s) identified. For example, the truck and trailer may have a total of three axles. Whereas current axle counting systems may identify a two axled vehicle and a one axle vehicle, the present system may correctly identify a three axled vehicle. The results may then be output and/or stored for use later (e.g., traffic studies, toll charging, etc.).

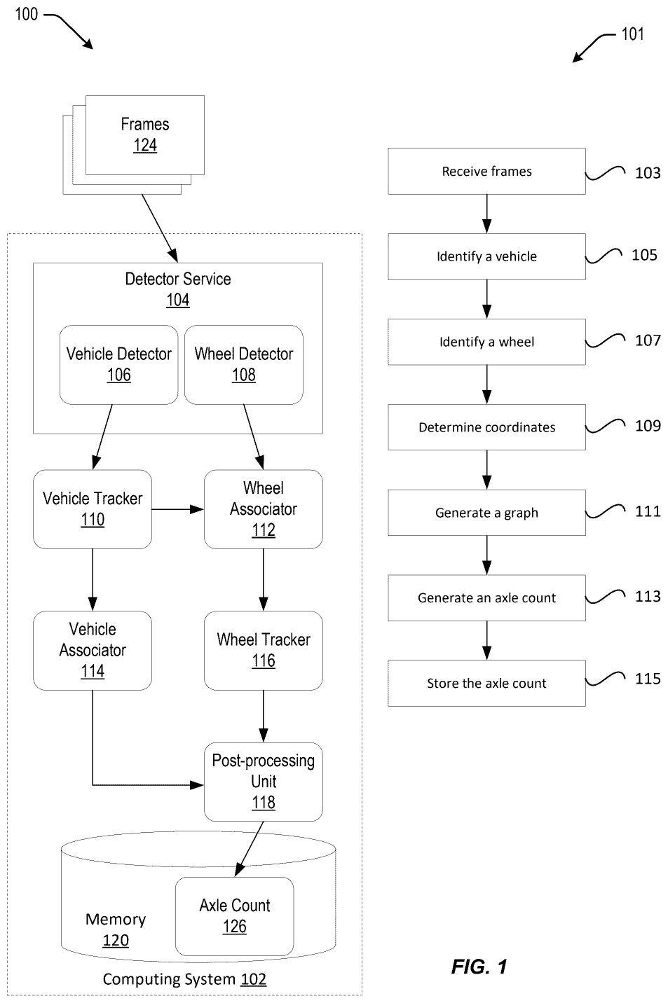

FIG. 1 illustrates a system 100 and a process 101 for generating an axle count for a vehicle, according to certain embodiments. The system 100 may include a computing system 102. The computing system 102 may include one or more physical and/or virtual machines working alone and/or in conjunction with one another to perform certain functions such as the processes and methods described herein. The computing system 102 may include one or more processors, computer-readable memory, and/or various communication components. The computing system 102 may also include a detector service 104 with a vehicle detector 106 and a wheel tracker 108, a vehicle tracker 110, a wheel associator 112, a vehicle associator 114, a wheel tracker 116, a post-processing unit 118, and a memory 120. The computing system 102 may be located in a single place, such as a toll collection booth on a road, bridge etc., or the computing system 102 may be a distributed system.

The detector service 104 may include one or more hardware and/or software components executed on a single computer device or on multiple computing devices. The detector service 104 may be configured to receive image data from one or more optical sensors such as cameras, video cameras, infrared detectors, etc. (collectively, “cameras”). For example, a toll bridge may include multiple lanes for traffic, with toll gates, booths, etc. for each lane. Each lane may have a respective camera positioned to capture image and/or video data of the respective lane. Then, each respective camera may have a dedicated detector service 104, such that each dedicated detector service 104 operates on a single lane. In another embodiment, all of the respective cameras may provide image data to a single detector service 104. Then, the detector service 104 may operate for all lanes. In yet another embodiment, a single camera may provide image data for all lanes and the detector service may parse and analyze the image data in a lane-by-lane basis. One or ordinary skill in the art would recognize many different possibilities and configurations.

The vehicle detector 106 may be a module or sub-service included in the detector service 104. The vehicle detector 106 may include one or more machine learning models (MLMs) such as convolutional neural networks CNNs, You Only Look Once (YOLO) models, decision trees, Naive Bayes models, and/or any other suitable models. The vehicle detector 106 may be trained on images of vehicles of various types such as cars, trucks, vans, utility vehicles, tractor trailers, bicycles, motorcycles, etc. The training images may be annotated provided to the MLMs prior to operation.

The wheel detector 108 may be a module or sub-service included in the detector service 104. The wheel detector 108 may include one or more MLMs such as CNNs, YOLO models, decision trees, Naive Bayes models, and/or any other suitable models. The wheel detector 108 may be trained using training image including wheels and/or vehicles. The wheel detector 108 may at least partially be trained using the same training images as those used to train the vehicle detector 106.

The vehicle tracker 110 may be configured to track a position of a vehicle identified by the vehicle detector 106 across multiple frames. For example, video may include multiple image frames, captured at a certain frame per second rate (FPS), (e.g., 10 FPS, 40 FPS, etc.). As a vehicle travels through the toll booth, the vehicle's position in a given frame will change because the vehicle moves in relation to the camera's field of view. The vehicle tracker 110 may therefore track the vehicle through a series of frames, validating the identification of a vehicle and/or identifying multiple vehicles (as in a trailer, described below).

The wheel associator 112 may be configured to receive an output from the vehicle detector 106, the wheel detector 108, and/or the vehicle tracker 110. The wheel associator 112 may combine some or all of the outputs in order to associate wheels detected by the wheel detector 108 with a vehicle(s) detected by the vehicle detector 106. For example, the vehicle detector 106 may identify 2 vehicles and a given series of frames, each with a respective number of wheels. The wheel associator 112 may then assign the wheels detected by the wheel detector 108 using the frame position and number for each of the 2 vehicles.

The vehicle associator 114 may be configured to receive an output from the vehicle tracker 110. The vehicle associator 114 may determine whether one or more vehicles identified by the vehicle detector 106 and/or the vehicle tracker 110 should be considered as separate vehicles or as a single vehicle (e.g., a truck pulling a trailer). The vehicle associator 114 may consider criteria such as vehicle position, vehicle separation, vehicle speed, and other such information in determining whether the vehicles within the frames should be considered a single vehicle.

The wheel tracker 116 may be configured to receive outputs from the wheel detector 108 and/or the wheel associator 112. The wheel tracker 116 may determine the coordinates of each wheel detected by the wheel detector 108 within each frame. The wheel tracker 116 may then perform one or more operations on the coordinates to more reliably track the position of each wheel through the series of frames. By tracking the path of each detected wheel through the series of frames, a more accurate count of wheels may be determined.

The post-processing unit 118 may receive outputs from the vehicle associator 114 and/or the wheel tracker 116. The post-processing unit 118 may parse data included in the outputs from the vehicle associator and/or the wheel tracker 116 to eliminate or reduce false positives and/or false negatives. The post-processing unit 118 may also be configured to generate a final axle count for identified vehicles (e.g., vehicles identified by the vehicle detector 106). The final axle counts may then be stored in the memory 120 for later processing.

At 103, the computing system 102 may receive a series of frames 124 from an optical sensor. The optical sensor may be a video camera pointed towards one or more lanes of traffic, toll booths, etc. The optical sensor (“camera”) may be pointed at any angle in relation to the lane of traffic where a field of view of the camera can capture wheels of a vehicle travelling through a lane of traffic. For example, the camera may be angled within a range of 2° to 178° relative to the direction of travel of vehicles through the lane. The camera may additionally or alternatively be angled from 900 to 175° relative to an orthogonal vertical direction in relation to the direction of travel of vehicles through the lane. Because the system 100 utilizes a series of frames, as well as because of the improved tracking methods described below, the system 100 may not be as sensitive to camera angle as current axle counting systems (ACS).

At 105, the series of frames 124 may be provided to the vehicle detector 106 of the detector service 104. The vehicle detector 106 may utilize one or more object detection MLMs trained to identify various vehicles in an image. For each frame of the series of frames 124, the vehicle detector 106 may analyze the frame (i.e., image data) to determine whether a vehicle is present within the frame. In some embodiments, the vehicle detector 106 may analyze the entire frame, identifying all vehicles that may be present within the frame. For example, the frame may include a view of multiple lanes, each including one or more vehicles. The vehicle detector 106 may then identify all of the vehicles. Additionally or alternatively, the vehicle detector 106 may then discard all vehicles that are outside of a specific region, such as a particular lane of traffic. The specific region may be predetermined (e.g., provided to the detector service 104 and/or the vehicle detector 106 as coordinates within a frame) or may be determined at least in part on the image data within each frame.

In other embodiments, the vehicle detector 106 may only analyze an ROI within the frame. For example, the ROI may be a specific region of the frame corresponding to a single lane of traffic. While the frame may include several representations of vehicles in multiple lanes, the vehicle detector 106 may only consider those vehicles within the ROI. In other words, the output of the vehicle detector 106 may be limited to only identify vehicles in a particular lane.

After the vehicle is detected by the vehicle detector 106, the series of frames 124 may be provide to the vehicle tracker 110. Each frame of the series of frames 124 may include a bounding box and confidence score around a representation of the vehicle. The bounding box and/or confidence score may be generated by the vehicle detector 106 (i.e., the series of frames is modified by the vehicle detector 106). As the vehicle is moving through the camera's field of view, each frame of the series of frames 124 may show the representation of the vehicle (“the vehicle”) in a different position. The vehicle tracker 110 may therefore determine whether the vehicle identified in each frame is the same vehicle. This may enhance the accuracy of the computing system 102. For example, in some frames of the series of frames 124, at least some of the wheels of the vehicle may not be visible, especially for long vehicles and/or trailers. By utilizing the series of frames 124 and tracking the vehicle through each of the frames, all wheels of the vehicle may be tracked, even if no single frame shows the entire vehicle.

After the vehicle is tracked, the vehicle associator 114 may determine whether two identified vehicles in the series of frames 124 should be considered a single vehicle. A truck pulling a trailer, for example, may appear to be two vehicles (as identified by the vehicle detector 106 and tracked by the vehicle tracker 110). However, the truck and trailer should be considered a single vehicle, and a toll charged based on the axles present on both the truck and the trailer. The vehicle associator 114 may then determine that the trailer is not a separate vehicle, but rather should be considered as part of the truck.

At 107, the series of frames 124 may be provided to the wheel detector 108. The wheel detector 108 may include one or more object detection MLMs trained to detect wheels and/or tires in an image. The wheel detector 108 may only detect wheel within an ROI or may identify all wheels within a given frame. For example, a car transporter may be a truck and trailer, with one or more cars carried on the trailer. The car transporter therefore may include wheel for the truck, for the trailer, and for the cars being carried. The wheel detector 108 may detect all of the wheel visible within the frame (even if the axles should not be counted towards a toll).

After the wheel detector 108 has identified the wheels, the series of 124 may be provided to the wheel associator 112. The wheel associator 112 may receive data from the vehicle detector 106 and/or the vehicle tracker 110. For example, the wheel associator 112 may receive predictions for each frame of the series of frames 124 showing the presence of a car within the frame. The wheel associator 112 may then receive data from the wheel detector 108 indicating that two wheels are present in the frame. The wheel associator 112 may then cause the wheels to be associated with the car.

At 109, the wheel tracker 116 may determine coordinates of the wheels identified by the wheel detector 108 and/or the wheel associator 112. For example, the wheel detector 108 may output the series of frames 124 with bounding boxes around each identified wheel. The bounding boxes may also include a confidence interval (e.g., 0.9, 90%, etc.) indicating the likelihood that the bounding box contains a wheel. The wheel tracker 116 may then determine the coordinates of the wheel(s) within the respective bounding boxes with respect to a given frame. Because the camera may be stationary, the field of view may be constant (or relatively so). This means that the x and y coordinates for each frame represent the same space. Thus, when a wheel is identified in the series of frames 124, the coordinates of the wheel change from frame to frame. Put differently, because the series of frames 124 represents images over a period of time, the wheel tracker 116 may track the wheel through space and time. The result may be (x, y, t) coordinates of the wheel through each of the series of frames 124.

At 111, the wheel tracker 116 may generate a graph based at least in part on some or all of the coordinates of the wheel. To generate the graph, the wheel tracker 116 may generate a 2-dimensional projection (sometimes, a “scatter plot”) of the (x, y, t) coordinates of the wheel. For example, the wheel tracker 116 may utilize principal component analysis (PCA) to project three dimensions into a 2-dimensional projection (i.e., (x, y, t)→(z, t)). The z values may be normalized for each of the series of frames 124 such that all coordinates are on the same scale.

Then, the wheel tracker 116 may transform the points of the 2-D projection. In some embodiments, the wheel tracker 116 may apply an inverse transform to the points on the scatter plot. The wheel tracker 116 may then apply a best fit curve to transformed points. Because the vehicle (theoretically, at least) travels in a straight line through the camera's field of view, the coordinates associated with the wheel on the transformed scatter plot may fall onto a roughly straight line or curve. If there are multiple wheels tracked by the wheel tracker 116, the transformed scatter plot may include multiple lines, each representing a wheel.

At 113, the wheel tracker 116 and/or the vehicle associator 114 may provide an output to the post-processing unit 118. The output may include an axle count and vehicle identifier and/or the transformed points with the best fit lines associated with the wheel(s). The post-processing unit 118 may verify the axle count using some or all of the output received from the vehicle associator 114 and/or the wheel tracker 116. For example, the detector service 104 may have detected a passenger car and two wheels in the series of frames 124. The system 100 may have tracked the two wheels to verify that the wheels are consistent throughout the series of frames 124 (e.g., no false positives/negatives, etc.) by using the various components described above. Thus, the post-processing unit 118 may determine that there are two axles associated with the passenger car. The car transporter, however, may be treated differently.

The wheel tracker 116 may have tracked all of the wheels of the truck and trailer of the car transporter and included data indicating so in the output. However, because the cars being carried by the transporter are higher (i.e., farther away from the road surface), the wheels of the cars on the transporter may have different coordinates than those on the roadway. Each vehicle moving on the roadway must have wheel in contact with the road surface. Therefore, the wheels of vehicles passing through the camera's field of view may have roughly the same coordinates, independent of wheel size, etc. The cars on the transporter, however, may have coordinates that are translated higher (e.g., a higher y value) than those of wheels in contact with the road surface. The post-processing unit 118 may therefore disregard any wheels identified whose coordinates are outside of a second ROI. Thus, even in the case of the car transporter, the correct number of axles may be counted and vehicles tolled appropriately.

At 115, the post-processing unit 118 may output an axle count 126 for storage in the memory 120. The axle count 126 may be used to charge an account associated with the vehicle (e.g., using the vehicle identifier), used for traffic projections/studies, or any other such use. Because the system 100 and process 101 uses a series of frames to detect wheels (and thereby axles) instead of a single frame, the axle count 126 may be more accurate than those generated by current methods and systems (e.g., accurately associating cars and trailers, etc.). The graphs generated by the system 100 may also make the axle count 126 more accurate, as each wheel may be tracked through the frames.

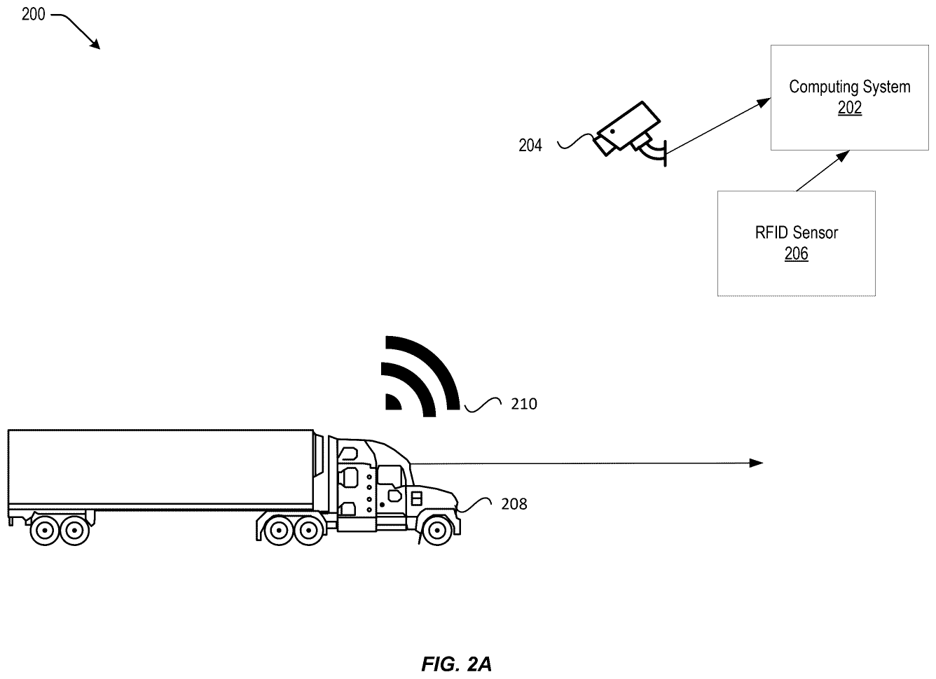

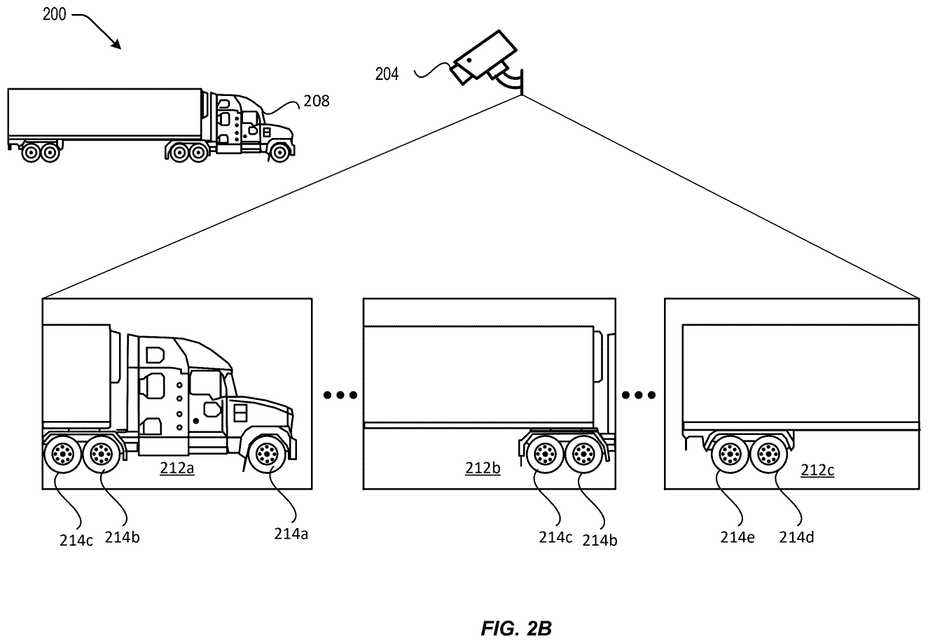

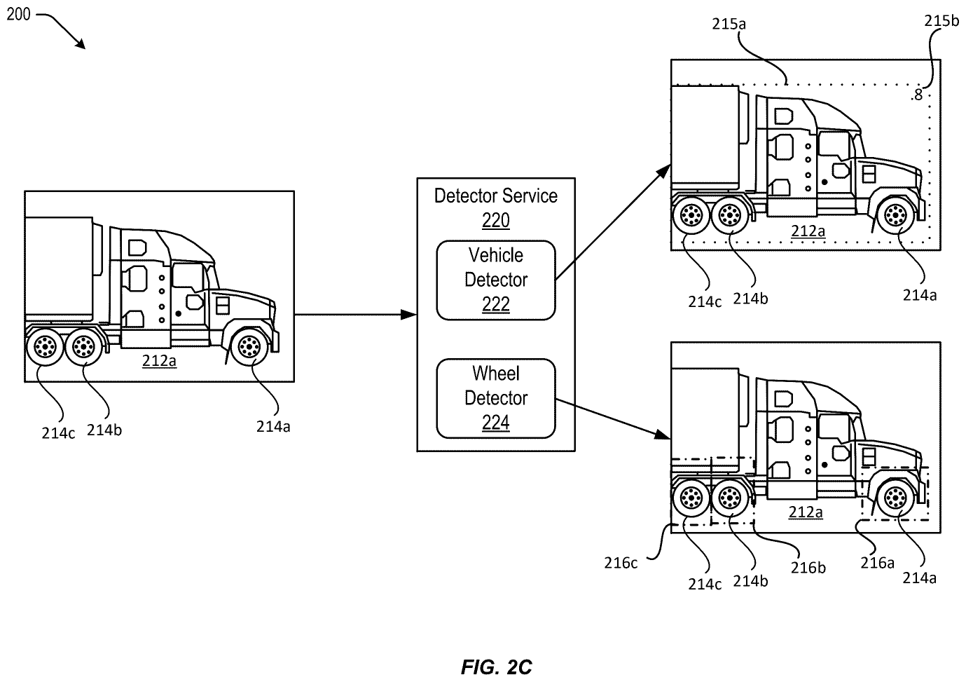

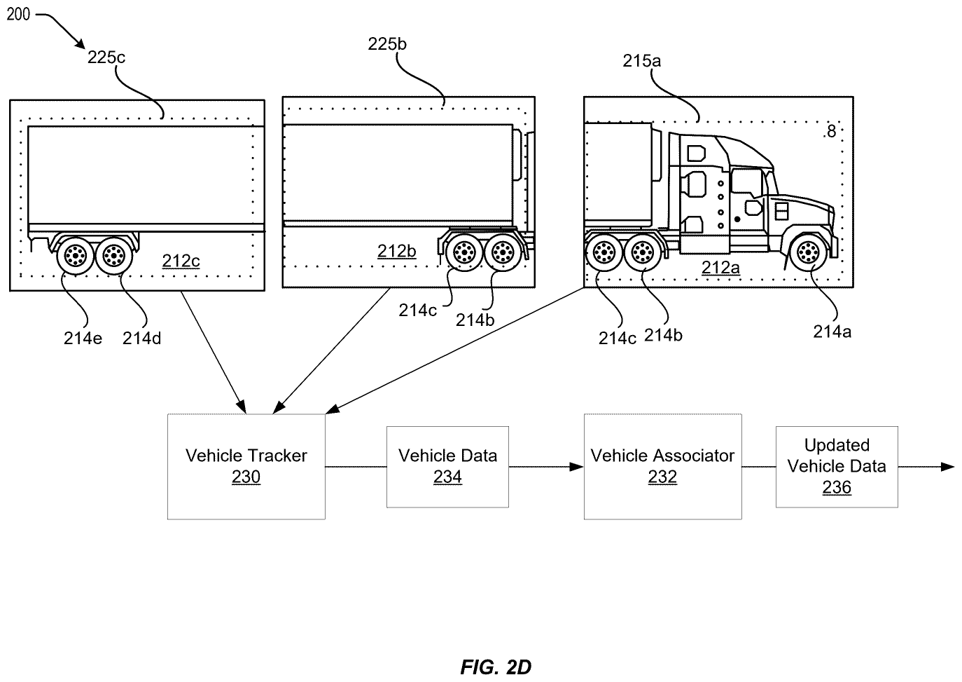

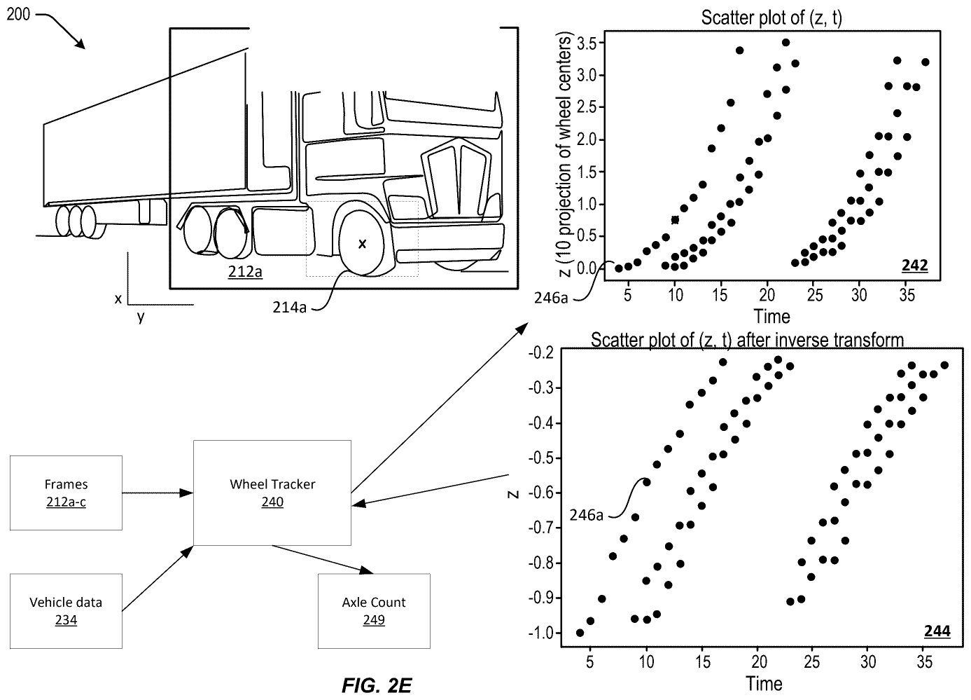

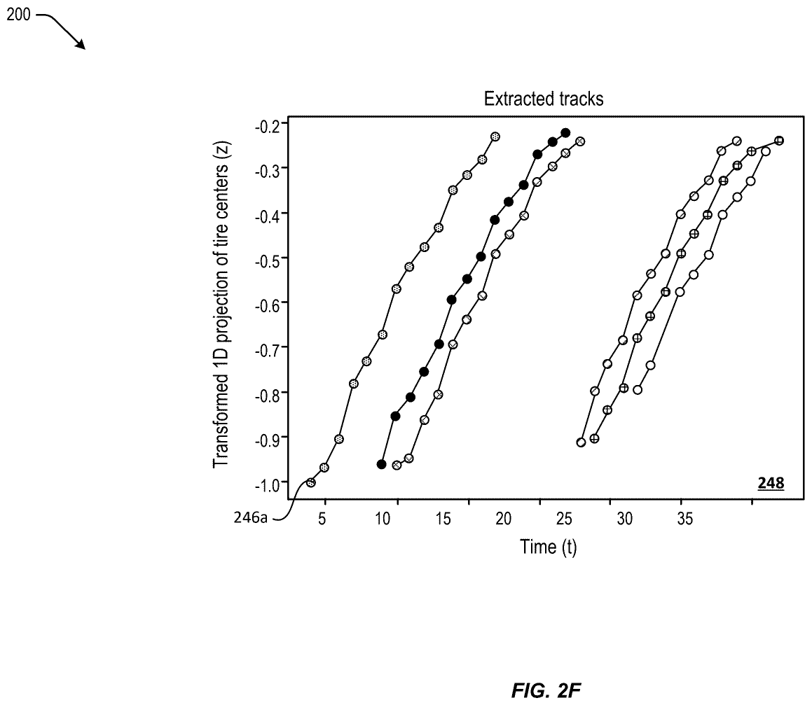

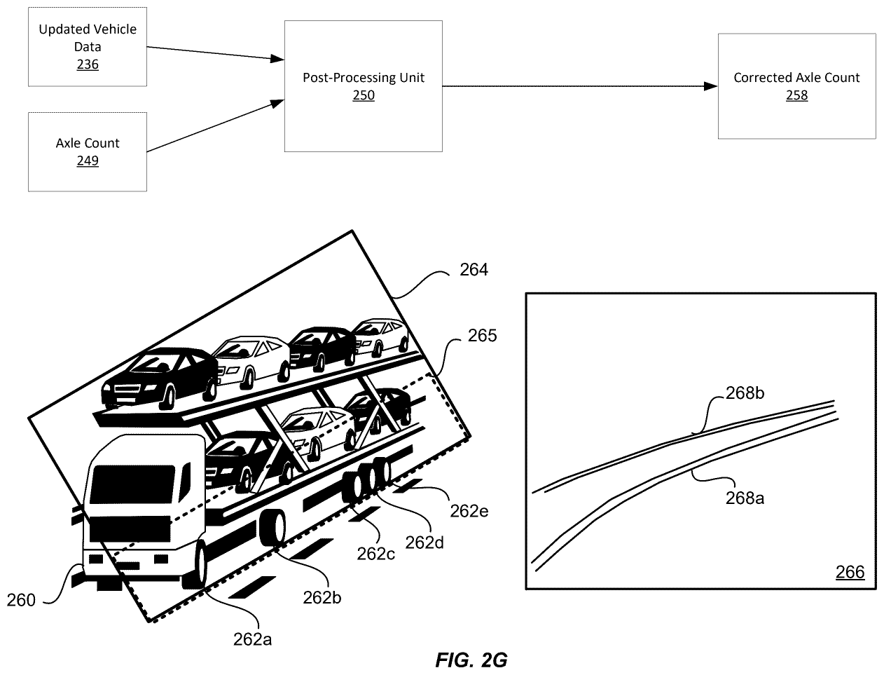

FIG. 2A illustrates a system 200 for counting axles of a vehicle 208, according to certain embodiments. The system 200 may include a computing system 202, a camera 204, and a radio frequency identifier (RFID) sensor 206. The computing system 200 may include one or more physical and/or virtual machines working in conjunction with one another. The computing system 202 may include some or all of the components described above in relation to the system 100.

The camera 204 may be a video camera, infrared camera, thermal imaging device, or any other optical sensor. The camera 204 may have a field of view trained on a toll booth, traffic lane, or other such area. The camera 204 may be stationary such that the field of view is consistent throughout the operation of the system 200. In some embodiments, the camera 204 may include tracking functionality. Then, as a vehicle passes through the field of view, the camera 204 may move in order to keep the vehicle in roughly the same position relative to the field of view.

The camera 204 may provide image data to the computing system 202. The image data may be constant (e.g., a live feed), or the camera 204 may provide the image data as discreet numbers of frames to the computing system 202 (e.g., 40 frames, 100 frames, etc.). The camera 204 may provide the image data (i.e., a series of frames) to the computing system 202 via a wireless and/or a wireless connection.

The RFID sensor 206 may be configured to receive transponder signals from vehicles passing through the toll booth. As seen in FIG. 2A, a vehicle 208 may travel through the toll booth containing some or all of the system 200. The vehicle 208 may include a transponder that broadcasts a signal 210. The RFID sensor 206 may receive the signal 210 and determine a vehicle identifier associated with the vehicle 208. The vehicle identifier may be used to indicate a number of axles associated with the vehicle. However, the number of axles associated with the identifier may be different that the number of axles actually present on the vehicle 208. For example, the vehicle identifier may be associated with a truck (as seen in FIG. 2A) with a first number of axles. However, if the truck is towing a trailer, the actual number of axles may be greater than the number of axles associated with the vehicle identifier. Then, other techniques may be used to determine an accurate axle count.

FIG. 2B illustrates a series of frames 212a-c representing the vehicle 208, according to certain embodiments. As the vehicle 208 passes through the field of view of the camera 204, each frame of the series of frames 212a-c may capture a different portion and/or perspective of the vehicle 208. Although FIG. 2B illustrates three frames 212a-c, any number of frames may be present in the series of frames (e.g., 5, 20, 100, etc.) As seen in FIG. 2B, the first frame 212a may capture the front of the vehicle 208 as the vehicle 208 enters the field of view of the camera 204. The first frame 212a may also capture wheels 214a-c of the vehicle 208. However, the vehicle 208 may be too long for the entire vehicle to be included in a single frame. Thus, the other frames may be used to generate an accurate axle count for the vehicle 208.

The frame 212b may represent the field of view of the camera 204 at a later time than the frame 212a. As the vehicle 208 is traveling through the field of view of the camera 204, a different portion of the vehicle 208 may be represented. As seen in FIG. 2B, the frame 212b may include the wheels 214b-c, but not the wheel 214a. Similar to the frame 212a, therefore, the frame 212b not include the whole vehicle 208 either.

The frame 212c may represent the field of view of the camera 204 at a later time than the frame 212b. As seen in FIG. 2B, the frame 212c may include the back end of the vehicle 208 as the vehicle 208 leaves the field of view of the camera 204. The frame 212c may include the wheel 214d-e but not the wheels 214a-c. Thus, no single frame of the series of frames 212a-c may include all of the axles of the vehicle 208.

Many current axles counting systems may utilize one image of the vehicle as it passes through the toll booth. As illustrated in FIG. 2B, however, no single frame may include all of the axles of the vehicle 208. Furthermore, utilizing a single frame to perform axle counting may be sensitive to the perspective of the camera with respect to the vehicle 208. For example, the perspective of the camera 204 illustrated in FIG. 2B may be exactly perpendicular to the direction of travel of the vehicle 208. Therefore, the wheels 214a-e may appear circular and relatively consistent throughout the frames 212a-c. If the perspective of the camera were shifted however (e.g., pointed in a direction other than orthogonal to the direction of travel), the wheels 214a-e may appear oblong, partially visible, and/or not visible in some or all of the frames 212a-c. Thus, even if a single frame could capture the entire vehicle 208, some or all of the wheels 214-ae may not be counted.

FIG. 2C illustrates the system 200 with a detector service 220, according to certain embodiments. The detector service 220 may be similar to the detector service 104 in FIG. 1. The detector service 220 may be implemented on the computing system 202. As opposed to current systems that only utilize a single detector, the detector service 220 may include a vehicle detector 222 and a wheel detector 224, each trained on separate training data. The accuracy of an axle count may be more accurate by utilizing a dedicated wheel detector (i.e., the wheel detector 224) versus using a vehicle detector (i.e., the vehicle detector 222). The detector architectures and respective computation budgets may be tuned separately, allowing each detector to operate more efficiently and utilizing less resources.

The vehicle detector 222 may include one or more MLMs configured to identify various vehicles from image data (e.g., a series of video frames). The MLMs may include CNNs, (YOLO) models, decision trees, Naive Bayes models, and/or any other suitable models. The vehicle detector 222 may be trained on images of vehicles of various types such as cars, trucks, vans, utility vehicles, tractor trailers, bicycles, motorcycles, etc. The training images may be annotated provided to the MLMs prior to operation, such as by a user. Furthermore, outputs of the vehicle detector 222 may be subsequently used to retrain one or more of the MLMs. By providing the outputs (and other training data) to the MLMs, the vehicle detector 222 may become more efficient and/or effective at identifying vehicles. For example, a large training set may include image of various vehicles from various angles. However, the camera 204 may be relatively stationary and only capture images of vehicles from a particular angle. The vehicle detector 222 may then be initially configured to identify vehicles from general angles, but become faster and more accurate in identifying vehicles from the particular angle based on feedback provided through the results.

One or more of the frames 212a-c may be provided to the vehicle detector 222. For each frame 212a-c, the vehicle detector 222 may analyze the image captured in the frame to determine whether a vehicle is present. As shown in FIG. 2C, the frame 212a may be provided to the vehicle detector 222. Using the MLMs as described above, the vehicle detector 222 may generate a bounding box 215a with a confidence interval 215b. The bounding box 215a may be an estimated region within the frame 212a where the vehicle 208 is detected. The bounding box 215a may be an axis-aligned bounding box, where the sides of the bounding box 215a are parallel to the sides of the frame 212a.

In other embodiments, the bounding box 215a may be an oriented bounding box, where the bounding box 215 is oriented to be substantially parallel to the vehicle 208. For example, if the field of view of the camera is oriented any way other than directly orthogonal to the direction of travel of the vehicle 208, edges of the vehicle 208 may not be parallel to any of the sides of the field of view of the camera 204. In other words, the direction of travel may be diagonal to the orientation of the field of view. An axis-oriented bounding box may then not include all of the vehicle 208 and/or may distort the detected image of the vehicle 208. An oriented bounding box may, on the other hand, may account for the angle of the camera 204 with respect to direction of travel, by aligning the bounding box 215a to the vehicle 208. Additionally or alternatively, the bounding box 215a may be oriented to a known landmark (e.g., a lane line painted on a road surface). As vehicles typically follow a known, consistent path through the field of view of the camera 204, the oriented bounding box may more reliably capture the vehicle 208. Additionally or alternatively, the bounding box 215a may be oriented in a configuration step before operation. Therefore the bounding box 215a may be consistent throughout frames.

The vehicle detector 222 may also output a confidence interval 215b with the bounding box 215a. The confidence interval 215b may represent a likelihood that the bounding box 215a includes the vehicle 208. Additionally or alternatively, the confidence interval 215b may represent a likelihood of the vehicle 208 being of a particular class. For example, the vehicle detector 222 may be trained to detect various classes of vehicles such as trucks, cars, motorcycles, tractors, etc. Thus, when analyzing the frame 212a, the vehicle detector 222 may output data indicating a vehicle class of the vehicle 208 and the confidence score 215b may represent the likelihood of the vehicle being of the vehicle class.

The frame 212a may also be provided to the wheel detector 224. The wheel detector 224 may include one or more MLMs. The MLMs may include CNNs, (YOLO) models, decision trees, Naive Bayes models, and/or any other suitable models. The MLMs may be trained using images of wheels of various sizes, colors, orientations, etc. For example a training data set may include images of truck wheels, tires, car tires, bicycles, motorcycles, roller skates, etc. The training data set may be annotated in order to provide a base level of functionality. Outputs of the wheel detector 224 may also be annotated and provided to the MLMs in order to better tune the MLMs. For example, the training data set may include images of wheels taken at various angles. However, the camera 204 may be relatively stationary and only capture images of vehicles from a particular angle. The wheel detector may then be initially configured to identify wheels from general angles, but become faster and more accurate in identifying wheels from the particular angle based on feedback provided through the results.

The wheel detector 224 may analyze the frame 212a to determine whether a wheel (e.g., the wheels 214a-c) are present. Using the MLMs (trained as noted above), the wheel detector 224 may generate a bounding box 216a-c around each identified wheel 214a-c. The bounding boxes 216-ac may be oriented bounding boxes (as described above), or may be axis-aligned bounding boxes. In some embodiments, the bounding boxes 216a-c may include confidence intervals. In other embodiments, the bounding boxes 216a-c may not include confidence intervals. Because the wheel detector 224 is separate from the vehicle detector 222, the detection of a wheel may be binary—there is either a wheel present in the frame or there is not. If the detectors were combined (as is common), the wheels may be detected within the bounding boxes of the vehicles. The distortion of images within the vehicle bounding boxes may cause false positives/negatives. Furthermore, because the wheel detector 224 is trained solely on images of wheel, the computing power needed for the vehicle detector 222 and the wheel detector 224 may be less than for a single detector.

FIG. 2D illustrates the system 200 with a vehicle tracker 230 and a vehicle associator 232, according to certain embodiments. The vehicle tracker 230 may be configured to receive data from the vehicle detector 222. The vehicle tracker 230 may determine coordinates of the vehicle 208 as the vehicle 208 passes through the field of view of the camera 204. For example, the vehicle tracker 230 may receive the frames 212a-c. The vehicle tracker 230 may then determine that each frame 212a-c includes an image of a vehicle. For example, the frame 212a may show a truck (part of the vehicle 208). Subsequent frames may also include the truck, but in a slightly different position relative to the frame. The vehicle tracker 230 may therefore determine that the truck in each of the frames is the same truck as in frame 212a.

Similarly, the vehicle tracker 230 may determine that a portion of the trailer included in the frame 212b is a second vehicle. Subsequent frames may also include the “second vehicle,” but in a slightly different position relative to the frame. The vehicle tracker 230 may therefore determine that the second vehicle in each of the frames is the same truck as in frame 212b. The vehicle tracker 230 may also determine that the trailer portion of the vehicle 208 is a third vehicle and track the “third vehicle” through subsequent frames.

The vehicle tracker 230 may then output vehicle data 234 and provide the vehicle data 234 to the vehicle associator 232. The vehicle associator 232 may determine that the “second vehicle” and the “third vehicle” are not actually separate vehicles, but rather are components of the truck shown in the frame 212a. For example, the vehicle associator 232 may include one or more MLMs specifically trained on data include trailers and the like. Additionally or alternatively, the vehicle associator 232 may include one or more rules-based filters. For example, the vehicle associator 232 may determine a velocity of each of the vehicles (or change therein) based on the respective positions of vehicles within the series of frames 212a-c. If the velocities match within a certain distance, then the vehicle associator 232 may determine that each of the “separate” vehicles are actually the vehicle 208. One of ordinary skill in the art would recognize many different possibilities. The vehicle associator 232 may then output updated vehicle data 236.

FIG. 2E illustrates the system 200 with a wheel tracker 240 tracking a position of the wheel 214a, according to certain embodiments. The frames 214a-c (and other frames in the series of frames) and/or the vehicle data 234 may be provided to a wheel tracker 240. Using the vehicle data 234, the wheel tracker 240 may determine that a given frame (or series of frames) includes a vehicle. Then, the wheel tracker 240 may determine that some or all of the wheels identified by the wheel detector 224 are associated with the vehicle. As seen in FIG. 2E, the frame 212a may include the truck portion of the vehicle 208. Thus, the wheel tracker 240 may track the wheels associated with the truck portion of the vehicle 208 throughout the series of frames.

The wheel tracker 240 may be configured to identify a center of each wheel detected by the wheel detector 224. For example, the wheel tracker 240 may determine the center of the bounding box surrounding the wheel 214a. While the center of the bounding box may not align perfectly with the center of the wheel 214a, the center of the bounding box may be a suitable approximation. Additionally or alternatively, the wheel tracker 240 may further determine the center of the wheel using some or all of the methods described above in relation to the wheel detector 224.

After determining the center of the wheel detector 214a, the wheel tracker may determine (x, y) coordinates of the center of the wheel 214a with respect to the frame 212a and subsequent frames. Tracking the center of the wheel 214 as it moves across the coordinates of the frames allows the position of the wheel 214a to be determined with respect to time. In other words, the series of frames allows the coordinates of the wheel 214a to be (x, y, t), where t is time. Assuming the vehicle 208 travels in a straight line, the (x, y, t) coordinate of the wheel 214a may be projected onto the direction of motion, and transform (x, y, t) to (z, t). The z component may be computed using principal component analysis (PCA) from the spatial coordinates (x,y) of all coordinates (i.e., from each frame) (x, y, t). In addition, the z components may be normalized.

Each of the (z, t) coordinates associated with the wheel 214a may then be projected on a scatterplot 242. It should be understood that the scatterplot 242 is presented for ease of visualization. The system 200 may or may not generate an actual scatterplot. As seen in FIG. 2E, the points on the scatterplot 242 may form rough groups. Each group of points may represent a particular wheel associated with the vehicle 208 in the series of frames. For example, the group 246a may represent the position of the wheel 214a, projected into the (z, t) space. However, the groups on the scatterplot 242 may be indeterminate, making individual wheel difficult to discern. Therefore, the wheel tracker 240 may transform some or all of the data to generate a transformed 2-D projection, visualized here as an inverse scatterplot 244.

To generate the inverse scatterplot 244, the wheel tracker may apply an inverse transform z←1/(1+c*z) where c is a constant. This transform may compensate for exponentially increasing distance between the data points as seen in the scatterplot 242. As the vehicle 208 approaches the camera 204, the center of the wheel 214a may cover more distance from one frame to the next frame even though the vehicle is moving at constant velocity. This is because of the perspective projection of the world onto the camera 204. After applying the inverse transform, the distance between the data points from one time instance to the next time instance becomes uniform as shown in inverse scatterplot 244. This standardization makes the tracks of points lie on approximate straight lines and may help perform downstream steps without considering a varying distance scale at different time instances (i.e., different frames).

FIG. 2F illustrates a track graph 248 generated by the wheel tracker 240, according to certain embodiments. The wheel tracker 240 may apply a best fit line algorithm to some or all of the groups of inverse scatterplot 244 to generate the track graph 248. The wheel tracker 240 may iteratively extract the tracks from the points on the inverse scatterplot 244 one track at a time.

The wheel tracker 240 may determine starting point z for a track (e.g., for the group 246a, now referred to as the track 246a). For example, the starting point may be the highest z value point among the points at the earliest time instance t. The wheel tracker 240 may then iteratively extend the track 246a by adding one point z_next at the next time instance (t+1). Each point z_next may satisfy

0<(z_next-z)<kΔz, where k>1.

In other words, z_next is searched within some tolerance from z. If such point is found, the point may be added to the track 246a. This process may continue until no point satisfies the criteria above. When no more such points are found, the wheel tracker 240 may stop finding points and record the track as belonging to a particular wheel (e.g., in a memory, register, etc.). The points belonging to the track 246a may then be removed from the total points. In other words, the points of the track 246a may be deleted from a temporary memory of the computing system 202 after the track 246a has been identified.

When all of the tracks within the track graph 248 have been identified, and the points cleared from the computing system 202, the wheel tracker 240 may determine an axle count associated with the vehicle 208. As seen in FIG. 2D, the vehicle 208 may have 6 wheels 214a-e visible in the frames 212a-c. Accordingly, the track graph 248 may include 6 separate tracks, indicating that the vehicle 208 has 6 axles. Thus, the wheel detector 240 may output an axle count 249, indicating that the vehicle 208 includes 6 axles.

FIG. 2G illustrates a post-processing unit 250 analyzing the axle count 249 and the updated vehicle data 236, according to certain embodiments. The vehicle 208 includes 6 axles, all of which are in contact with the ground. Sometimes, however, a vehicle may be carrying other vehicles. The vehicles being carried may not count as having axles for the purposes of toll collection, traffic studies, etc. The post-processing unit 250 may be configured to parse the updated vehicle data 236, the axle count 249, and/or some or all of the frames used to generate the axle count 249 to generate a corrected axle count 258.

As seen in FIG. 2F, the vehicle 260 may be a car transporter. The vehicle 260 may include 5 axles, so five wheels 262a-e may be visible in the series of frames. However, the cars on the back of the vehicle 260 also have visible wheels. The vehicle detector 222 may therefore correctly generate the bounding box 264 to include the cars on the back of the vehicle 260. However, the wheel detector 224 may detect the wheels of the cars, and the wheel tracker 240 may identify the wheels and generate the track graph 266. The first track 268a may be the tracks associated with the center of the wheels 262a-e. A second track(s) 268b may represent the center of the wheels of the cars. In some embodiments, the post-processing unit 250 may determine that the second track 268b (and coordinates thereof) may start too high on the track graph 266. While wheels may differ in size, the center of any wheel in contact with the road surface may be within a certain distance from the road surface (e.g., a foot, 14 inches, etc.) and have a corresponding range on the scatterplot 242 and the subsequent track graph 266. Thus, the post-processing unit 250 may remove tracks that start too high on the track graph 266, as any such track is likely not associated with the vehicle 260.

In other embodiments, the post-processing unit 250 may generate a second bounding box 265 around wheels determined to be closest to the road surface (e.g., using the (x, y) coordinates of a given frame). Then, the post-processing unit 250 may disregard any tracks in the track graph 266 that are outside of the second bounding box 265 (or correspond to points outside the second bounding box 265). Thus, the corrected axle count 258 may only include the axles associated with the vehicle 260 (e.g., the wheels 262a-e). The corrected axle count 258 may then be stored for later processing (e.g., charging an account, traffic studies, etc.).

The corrected axle count 258 may also be used to verify a historical axle count of the vehicle. For example, the signal 210 may indicate that the vehicle 208 is a truck with three axles. However, as seen in FIGS. 2A-2F, the vehicle 208 may actually have 6 axles (when towing a trailer). Thus, the corrected axle count 258 may be used to verify the actual number of axles of the vehicle 208 instead of relying on the vehicle data.

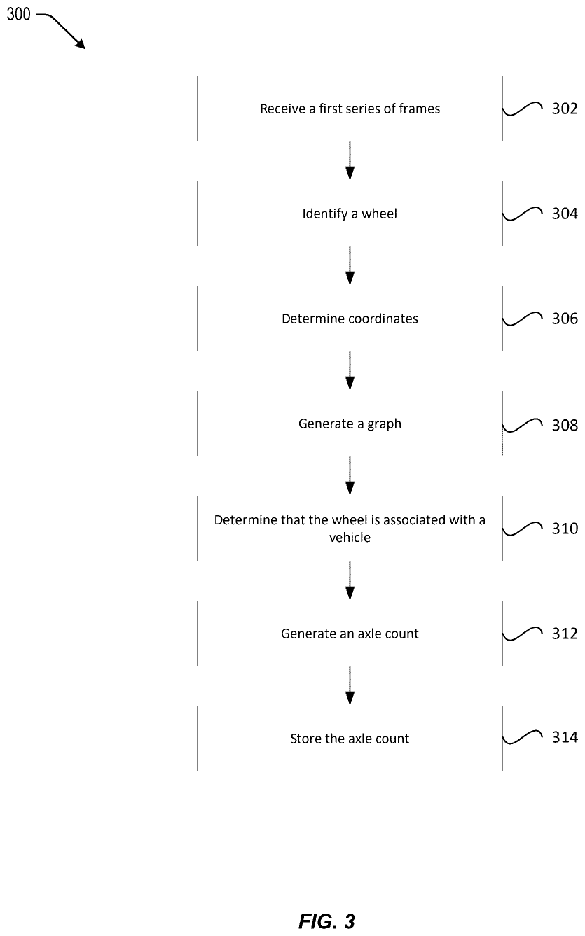

FIG. 3 illustrates a flowchart of a method 300 for generating an axle count, according to certain embodiments. The method 300 may be performed by some or all of the systems described herein, such as the systems 100 and/or 200 in FIGS. 1-2G, respectively. The steps of the method 300 may be performed in a different order than is described and/or some steps may be combined with other steps. In some embodiments, some steps may be skipped altogether.

At step 302, the method 300 may include receiving, by a computing system, a first series of frames of image data including a representation of a vehicle. The computing system may receive the first series of frames from an optical sensor, such as the camera 204. The image data may be constant (e.g., a live feed), or the camera may provide the image data as discreet numbers of frames to the computing system (e.g., 40 frames, 100 frames, etc.). The camera may provide the image data (i.e., a series of frames) to the computing system via a wireless and/or a wireless connection. The first series of frames of image data may represent a vehicle passing through a field of view of the camera. Thus, each frame of the first series of frames may show the vehicle in a slightly different position, relative to adjacent frames.

At step 304, for each frame of the first series of frames of image data, the method 300 may include identifying, by the computing system, a wheel based at least in part on at least a portion of the frame of the image data. The wheel may be identified by a wheel detector such as the wheel detector 224. The wheel detector may include one or more MLMs. The MLMs may include CNNs, YOLO models, decision trees, Naive Bayes models, and/or any other suitable models. The MLMs may be trained using images of wheels of various sizes, colors, orientations, etc. For example a training data set may include images of truck wheels, tires, car tires, bicycles, motorcycles, roller skates, etc. The training data set may be annotated in order to provide a base level of functionality. Outputs of the wheel detector may also be annotated and provided to the MLMs in order to better tune the MLMs. For example, the training data set may include images of wheels taken at various angles. However, the camera may be relatively stationary and only capture images of vehicles from a particular angle. The wheel detector may then be initially configured to identify wheels from general angles, but become faster and more accurate in identifying wheels from the particular angle based on feedback provided through the results.

At step 306, the method 300 may include determining, by the computing system, a set of coordinates indicating a position of the wheel within the frame of the image data. For example, the position of the wheel may be determined by a wheel tracker such as the wheel tracker 240. The wheel tracker may be configured to identify a center of each wheel detected by the wheel detector. For example, the wheel tracker may determine the center of the bounding box surrounding the wheel. While the center of the bounding box may not align perfectly with the center of the wheel, the center of the bounding box may be a suitable approximation. Additionally or alternatively, the wheel tracker may determine the center of the wheel using some or all of the methods described above in relation to the wheel detector.

After determining the center of the wheel detector, the wheel tracker may determine (x, y) coordinates of the center of the wheel with respect to the frame and subsequent frames. Tracking the center of the wheel as it moves across the coordinates of the frames allows the position of the wheel to be determined with respect to time. In other words, the series of frames allows the coordinates of the wheel to be (x, y, t), where t is time.

At step 308, the method 300 may include generating, by the computing system, a graph based on the set of coordinates indicating the position of each wheel identified in each frame of the first series of frames of the image data. To generate the graph, the wheel tracker may generate a scatterplot such as the scatterplot 242. The wheel tracker may then apply a transform such as an inverse transform to generate a inverse scatterplot such as the inverse scatterplot 244. The wheel tracker may then apply one or more best fit lines to the inverse scatterplot to generate a track graph such as the track graph 248. The computing system (e.g., the wheel tracker) may then extract the tracks and remove points from the scatterplots/graphs to iteratively identify multiple tracks.

At step 310, the method 300 may include determining, by the computing system, that the wheel is associated with the vehicle. The wheel may be associated with the car by a service such as a wheel associator. The wheel associator may receive data indicating a vehicle within the first series of frames of image data. Then, the wheel associator may determine that wheel identified in the first series of frames of image data is associated with the vehicle.

At step 312, the method 300 may include generating an axle count of the vehicle, based at least in part on the graph. For example, each track identified in the track graph may represent a wheel of the vehicle. Therefore, each track may represent an axle of the vehicle. The computing system may then generate the axle count by summing the number of tracks identified in the track graph.

At 314, the method 300 may include storing the axle count for later processing. The axle count may be stored locally by the computing system or remotely. The axle count may be used for toll-charging, traffic studies, or any other such use.

### BRIEF DESCRIPTION OF DRAWINGS

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

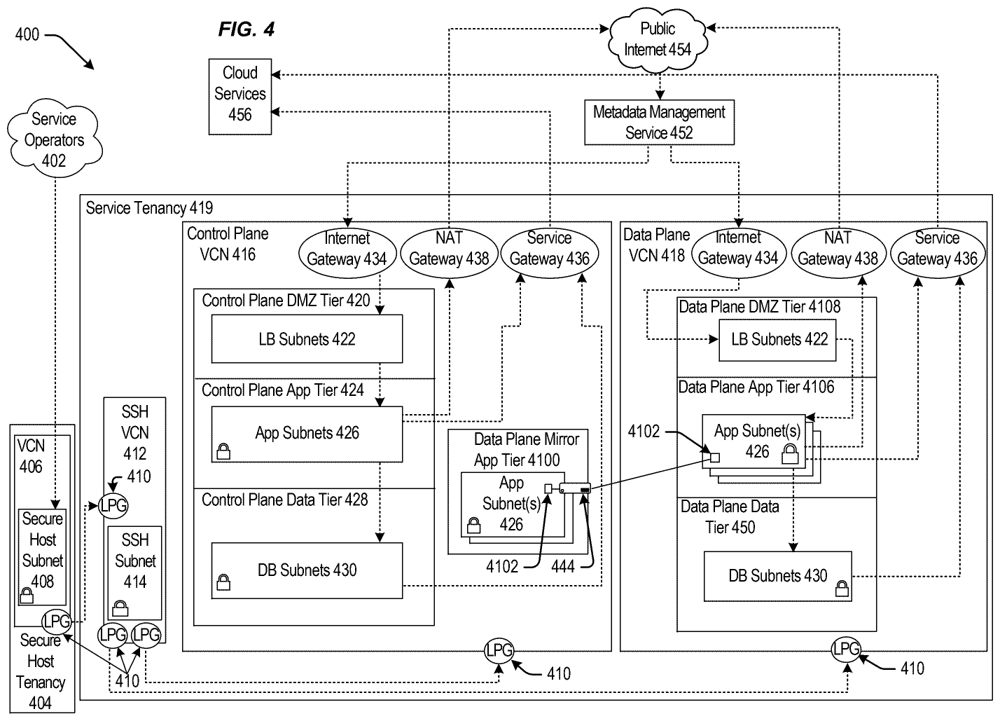

FIG. 4 is a block diagram 400 illustrating an example pattern of an IaaS architecture, according to at least one embodiment. Service operators 402 can be communicatively coupled to a secure host tenancy 404 that can include a virtual cloud network (VCN) 406 and a secure host subnet 408. In some examples, the service operators 402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 406 and/or the Internet.

The VCN 406 can include a local peering gateway (LPG) 410 that can be communicatively coupled to a secure shell (SSH) VCN 412 via an LPG 410 contained in the SSH VCN 412. The SSH VCN 412 can include an SSH subnet 414, and the SSH VCN 412 can be communicatively coupled to a control plane VCN 416 via the LPG 410 contained in the control plane VCN 416. Also, the SSH VCN 412 can be communicatively coupled to a data plane VCN 418 via an LPG 410. The control plane VCN 416 and the data plane VCN 418 can be contained in a service tenancy 419 that can be owned and/or operated by the IaaS provider.

The control plane VCN 416 can include a control plane demilitarized zone (DMZ) tier 420 that acts as a perimeter network (e.g., portions of a corporate network between the corporate intranet and external networks). The DMZ-based servers may have restricted responsibilities and help keep breaches contained. Additionally, the DMZ tier 420 can include one or more load balancer (LB) subnet(s) 422, a control plane app tier 424 that can include app subnet(s) 426, a control plane data tier 428 that can include database (DB) subnet(s) 430 (e.g., frontend DB subnet(s) and/or backend DB subnet(s)). The LB subnet(s) 422 contained in the control plane DMZ tier 420 can be communicatively coupled to the app subnet(s) 426 contained in the control plane app tier 424 and an Internet gateway 434 that can be contained in the control plane VCN 416, and the app subnet(s) 426 can be communicatively coupled to the DB subnet(s) 430 contained in the control plane data tier 428 and a service gateway 436 and a network address translation (NAT) gateway 438. The control plane VCN 416 can include the service gateway 436 and the NAT gateway 438.

The control plane VCN 416 can include a data plane mirror app tier 440 that can include app subnet(s) 426. The app subnet(s) 426 contained in the data plane mirror app tier 440 can include a virtual network interface controller (VNIC) 442 that can execute a compute instance 444. The compute instance 444 can communicatively couple the app subnet(s) 426 of the data plane mirror app tier 440 to app subnet(s) 426 that can be contained in a data plane app tier 446.

The data plane VCN 418 can include the data plane app tier 446, a data plane DMZ tier 448, and a data plane data tier 450. The data plane DMZ tier 448 can include LB subnet(s) 422 that can be communicatively coupled to the app subnet(s) 426 of the data plane app tier 446 and the Internet gateway 434 of the data plane VCN 418. The app subnet(s) 426 can be communicatively coupled to the service gateway 436 of the data plane VCN 418 and the NAT gateway 438 of the data plane VCN 418. The data plane data tier 450 can also include the DB subnet(s) 430 that can be communicatively coupled to the app subnet(s) 426 of the data plane app tier 446.

The Internet gateway 434 of the control plane VCN 416 and of the data plane VCN 418 can be communicatively coupled to a metadata management service 452 that can be communicatively coupled to public Internet 454. Public Internet 454 can be communicatively coupled to the NAT gateway 438 of the control plane VCN 416 and of the data plane VCN 418. The service gateway 436 of the control plane VCN 416 and of the data plane VCN 418 can be communicatively coupled to cloud services 456.

In some examples, the service gateway 436 of the control plane VCN 416 or of the data plane VCN 418 can make application programming interface (API) calls to cloud services 456 without going through public Internet 454. The API calls to cloud services 456 from the service gateway 436 can be one-way: the service gateway 436 can make API calls to cloud services 456, and cloud services 456 can send requested data to the service gateway 436. But, cloud services 456 may not initiate API calls to the service gateway 436.

In some examples, the secure host tenancy 404 can be directly connected to the service tenancy 419, which may be otherwise isolated. The secure host subnet 408 can communicate with the SSH subnet 414 through an LPG 410 that may enable two-way communication over an otherwise isolated system. Connecting the secure host subnet 408 to the SSH subnet 414 may give the secure host subnet 408 access to other entities within the service tenancy 419.

The control plane VCN 416 may allow users of the service tenancy 419 to set up or otherwise provision desired resources. Desired resources provisioned in the control plane VCN 416 may be deployed or otherwise used in the data plane VCN 418. In some examples, the control plane VCN 416 can be isolated from the data plane VCN 418, and the data plane mirror app tier 440 of the control plane VCN 416 can communicate with the data plane app tier 446 of the data plane VCN 418 via VNICs 442 that can be contained in the data plane mirror app tier 440 and the data plane app tier 446.

In some examples, users of the system, or customers, can make requests, for example create, read, update, or delete (CRUD) operations, through public Internet 454 that can communicate the requests to the metadata management service 452. The metadata management service 452 can communicate the request to the control plane VCN 416 through the Internet gateway 434. The request can be received by the LB subnet(s) 422 contained in the control plane DMZ tier 420. The LB subnet(s) 422 may determine that the request is valid, and in response to this determination, the LB subnet(s) 422 can transmit the request to app subnet(s) 426 contained in the control plane app tier 424. If the request is validated and requires a call to public Internet 454, the call to public Internet 454 may be transmitted to the NAT gateway 438 that can make the call to public Internet 454. Metadata that may be desired to be stored by the request can be stored in the DB subnet(s) 430.

In some examples, the data plane mirror app tier 440 can facilitate direct communication between the control plane VCN 416 and the data plane VCN 418. For example, changes, updates, or other suitable modifications to configuration may be desired to be applied to the resources contained in the data plane VCN 418. Via a VNIC 442, the control plane VCN 416 can directly communicate with, and can thereby execute the changes, updates, or other suitable modifications to configuration to, resources contained in the data plane VCN 418.

In some embodiments, the control plane VCN 416 and the data plane VCN 418 can be contained in the service tenancy 419. In this case, the user, or the customer, of the system may not own or operate either the control plane VCN 416 or the data plane VCN 418. Instead, the IaaS provider may own or operate the control plane VCN 416 and the data plane VCN 418, both of which may be contained in the service tenancy 419. This embodiment can enable isolation of networks that may prevent users or customers from interacting with other users', or other customers', resources. Also, this embodiment may allow users or customers of the system to store databases privately without needing to rely on public Internet 454, which may not have a desired level of threat prevention, for storage.

In other embodiments, the LB subnet(s) 422 contained in the control plane VCN 416 can be configured to receive a signal from the service gateway 436. In this embodiment, the control plane VCN 416 and the data plane VCN 418 may be configured to be called by a customer of the IaaS provider without calling public Internet 454. Customers of the IaaS provider may desire this embodiment since database(s) that the customers use may be controlled by the IaaS provider and may be stored on the service tenancy 419, which may be isolated from public Internet 454.

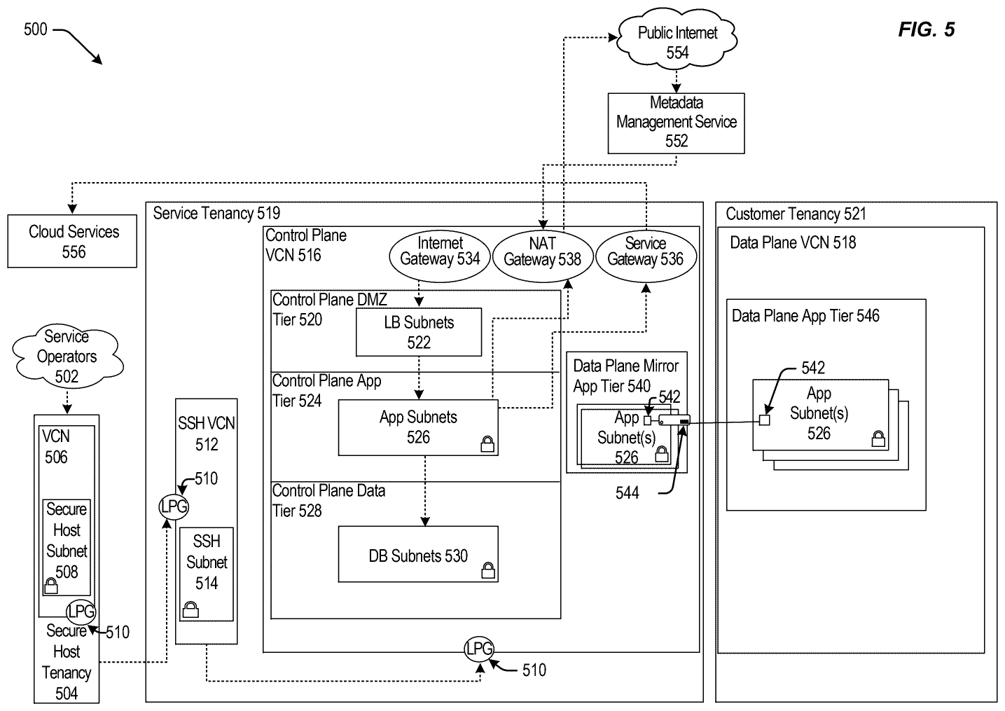

FIG. 5 is a block diagram 500 illustrating another example pattern of an IaaS architecture, according to at least one embodiment. Service operators 502 (e.g., service operators 402 of FIG. 4) can be communicatively coupled to a secure host tenancy 504 (e.g., the secure host tenancy 404 of FIG. 4) that can include a virtual cloud network (VCN) 506 (e.g., the VCN 406 of FIG. 4) and a secure host subnet 508 (e.g., the secure host subnet 408 of FIG. 4). The VCN 506 can include a local peering gateway (LPG) 510 (e.g., the LPG 410 of FIG. 4) that can be communicatively coupled to a secure shell (SSH) VCN 512 (e.g., the SSH VCN 412 of FIG. 4) via an LPG 410 contained in the SSH VCN 512. The SSH VCN 512 can include an SSH subnet 514 (e.g., the SSH subnet 414 of FIG. 4), and the SSH VCN 512 can be communicatively coupled to a control plane VCN 516 (e.g., the control plane VCN 416 of FIG. 4) via an LPG 510 contained in the control plane VCN 516. The control plane VCN 516 can be contained in a service tenancy 519 (e.g., the service tenancy 419 of FIG. 4), and the data plane VCN 518 (e.g., the data plane VCN 418 of FIG. 4) can be contained in a customer tenancy 521 that may be owned or operated by users, or customers, of the system.

The control plane VCN 516 can include a control plane DMZ tier 520 (e.g., the control plane DMZ tier 420 of FIG. 4) that can include LB subnet(s) 522 (e.g., LB subnet(s) 422 of FIG. 4), a control plane app tier 524 (e.g., the control plane app tier 424 of FIG. 4) that can include app subnet(s) 526 (e.g., app subnet(s) 426 of FIG. 4), a control plane data tier 528 (e.g., the control plane data tier 428 of FIG. 4) that can include database (DB) subnet(s) 530 (e.g., similar to DB subnet(s) 430 of FIG. 4). The LB subnet(s) 522 contained in the control plane DMZ tier 520 can be communicatively coupled to the app subnet(s) 526 contained in the control plane app tier 524 and an Internet gateway 534 (e.g., the Internet gateway 434 of FIG. 4) that can be contained in the control plane VCN 516, and the app subnet(s) 526 can be communicatively coupled to the DB subnet(s) 530 contained in the control plane data tier 528 and a service gateway 536 (e.g., the service gateway 436 of FIG. 4) and a network address translation (NAT) gateway 538 (e.g., the NAT gateway 438 of FIG. 4). The control plane VCN 516 can include the service gateway 536 and the NAT gateway 538.

The control plane VCN 516 can include a data plane mirror app tier 540 (e.g., the data plane mirror app tier 440 of FIG. 4) that can include app subnet(s) 526. The app subnet(s) 526 contained in the data plane mirror app tier 540 can include a virtual network interface controller (VNIC) 542 (e.g., the VNIC of 442) that can execute a compute instance 544 (e.g., similar to the compute instance 444 of FIG. 4). The compute instance 544 can facilitate communication between the app subnet(s) 526 of the data plane mirror app tier 540 and the app subnet(s) 526 that can be contained in a data plane app tier 546 (e.g., the data plane app tier 446 of FIG. 4) via the VNIC 542 contained in the data plane mirror app tier 540 and the VNIC 542 contained in the data plane app tier 546.

The Internet gateway 534 contained in the control plane VCN 516 can be communicatively coupled to a metadata management service 552 (e.g., the metadata management service 452 of FIG. 4) that can be communicatively coupled to public Internet 554 (e.g., public Internet 454 of FIG. 4). Public Internet 554 can be communicatively coupled to the NAT gateway 538 contained in the control plane VCN 516. The service gateway 536 contained in the control plane VCN 516 can be communicatively coupled to cloud services 556 (e.g., cloud services 456 of FIG. 4).

In some examples, the data plane VCN 518 can be contained in the customer tenancy 521. In this case, the IaaS provider may provide the control plane VCN 516 for each customer, and the IaaS provider may, for each customer, set up a unique compute instance 544 that is contained in the service tenancy 519. Each compute instance 544 may allow communication between the control plane VCN 516, contained in the service tenancy 519, and the data plane VCN 518 that is contained in the customer tenancy 521. The compute instance 544 may allow resources, that are provisioned in the control plane VCN 516 that is contained in the service tenancy 519, to be deployed or otherwise used in the data plane VCN 518 that is contained in the customer tenancy 521.

In other examples, the customer of the IaaS provider may have databases that live in the customer tenancy 521. In this example, the control plane VCN 516 can include the data plane mirror app tier 540 that can include app subnet(s) 526. The data plane mirror app tier 540 can reside in the data plane VCN 518, but the data plane mirror app tier 540 may not live in the data plane VCN 518. That is, the data plane mirror app tier 540 may have access to the customer tenancy 521, but the data plane mirror app tier 540 may not exist in the data plane VCN 518 or be owned or operated by the customer of the IaaS provider. The data plane mirror app tier 540 may be configured to make calls to the data plane VCN 518 but may not be configured to make calls to any entity contained in the control plane VCN 516. The customer may desire to deploy or otherwise use resources in the data plane VCN 518 that are provisioned in the control plane VCN 516, and the data plane mirror app tier 540 can facilitate the desired deployment, or other usage of resources, of the customer.

In some embodiments, the customer of the IaaS provider can apply filters to the data plane VCN 518. In this embodiment, the customer can determine what the data plane VCN 518 can access, and the customer may restrict access to public Internet 554 from the data plane VCN 518. The IaaS provider may not be able to apply filters or otherwise control access of the data plane VCN 518 to any outside networks or databases. Applying filters and controls by the customer onto the data plane VCN 518, contained in the customer tenancy 521, can help isolate the data plane VCN 518 from other customers and from public Internet 554.

In some embodiments, cloud services 556 can be called by the service gateway 536 to access services that may not exist on public Internet 554, on the control plane VCN 516, or on the data plane VCN 518. The connection between cloud services 556 and the control plane VCN 516 or the data plane VCN 518 may not be live or continuous. Cloud services 556 may exist on a different network owned or operated by the IaaS provider. Cloud services 556 may be configured to receive calls from the service gateway 536 and may be configured to not receive calls from public Internet 554. Some cloud services 556 may be isolated from other cloud services 556, and the control plane VCN 516 may be isolated from cloud services 556 that may not be in the same region as the control plane VCN 516. For example, the control plane VCN 516 may be located in “Region 1,” and cloud service “Deployment 4,” may be located in Region 1 and in “Region 2.” If a call to Deployment 4 is made by the service gateway 536 contained in the control plane VCN 516 located in Region 1, the call may be transmitted to Deployment 4 in Region 1. In this example, the control plane VCN 516, or Deployment 4 in Region 1, may not be communicatively coupled to, or otherwise in communication with, Deployment 4 in Region 2.

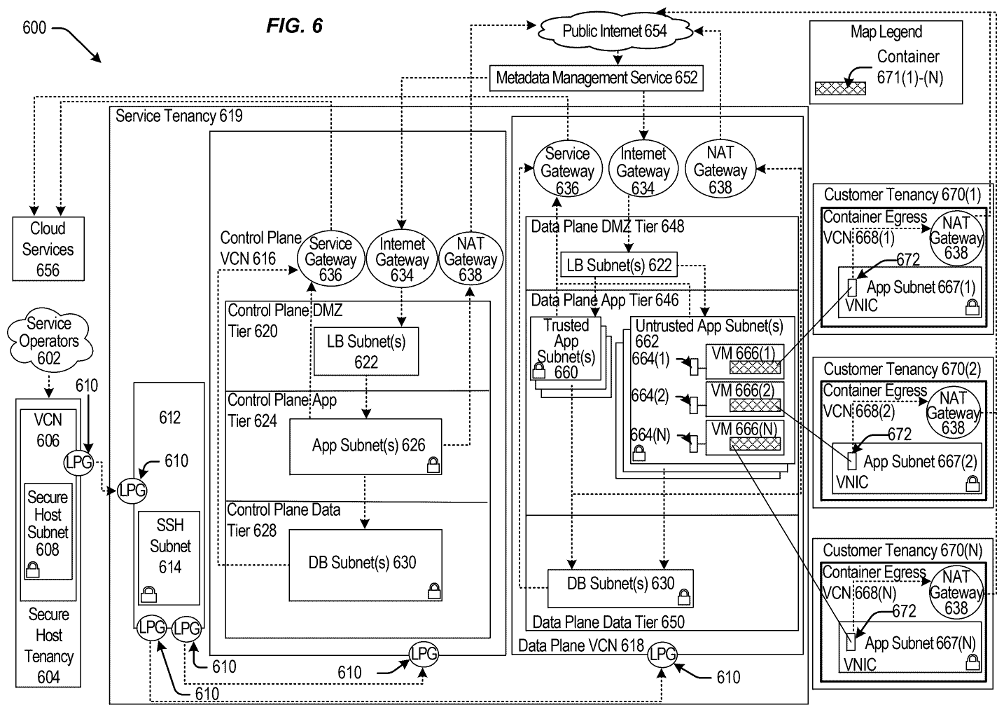

FIG. 6 is a block diagram 600 illustrating another example pattern of an IaaS architecture, according to at least one embodiment. Service operators 602 (e.g., service operators 402 of FIG. 4) can be communicatively coupled to a secure host tenancy 604 (e.g., the secure host tenancy 404 of FIG. 4) that can include a virtual cloud network (VCN) 606 (e.g., the VCN 406 of FIG. 4) and a secure host subnet 608 (e.g., the secure host subnet 408 of FIG. 4). The VCN 606 can include an LPG 610 (e.g., the LPG 410 of FIG. 4) that can be communicatively coupled to an SSH VCN 612 (e.g., the SSH VCN 412 of FIG. 4) via an LPG 610 contained in the SSH VCN 612. The SSH VCN 612 can include an SSH subnet 614 (e.g., the SSH subnet 414 of FIG. 4), and the SSH VCN 612 can be communicatively coupled to a control plane VCN 616 (e.g., the control plane VCN 416 of FIG. 4) via an LPG 610 contained in the control plane VCN 616 and to a data plane VCN 618 (e.g., the data plane 418 of FIG. 4) via an LPG 610 contained in the data plane VCN 618. The control plane VCN 616 and the data plane VCN 618 can be contained in a service tenancy 619 (e.g., the service tenancy 419 of FIG. 4).

The control plane VCN 616 can include a control plane DMZ tier 620 (e.g., the control plane DMZ tier 420 of FIG. 4) that can include load balancer (LB) subnet(s) 622 (e.g., LB subnet(s) 422 of FIG. 4), a control plane app tier 624 (e.g., the control plane app tier 424 of FIG. 4) that can include app subnet(s) 626 (e.g., similar to app subnet(s) 426 of FIG. 4), a control plane data tier 628 (e.g., the control plane data tier 428 of FIG. 4) that can include DB subnet(s) 630. The LB subnet(s) 622 contained in the control plane DMZ tier 620 can be communicatively coupled to the app subnet(s) 626 contained in the control plane app tier 624 and to an Internet gateway 634 (e.g., the Internet gateway 434 of FIG. 4) that can be contained in the control plane VCN 616, and the app subnet(s) 626 can be communicatively coupled to the DB subnet(s) 630 contained in the control plane data tier 628 and to a service gateway 636 (e.g., the service gateway of FIG. 4) and a network address translation (NAT) gateway 638 (e.g., the NAT gateway 438 of FIG. 4). The control plane VCN 616 can include the service gateway 636 and the NAT gateway 638.

The data plane VCN 618 can include a data plane app tier 646 (e.g., the data plane app tier 446 of FIG. 4), a data plane DMZ tier 648 (e.g., the data plane DMZ tier 448 of FIG. 4), and a data plane data tier 650 (e.g., the data plane data tier 450 of FIG. 4). The data plane DMZ tier 648 can include LB subnet(s) 622 that can be communicatively coupled to trusted app subnet(s) 660 and untrusted app subnet(s) 662 of the data plane app tier 646 and the Internet gateway 634 contained in the data plane VCN 618. The trusted app subnet(s) 660 can be communicatively coupled to the service gateway 636 contained in the data plane VCN 618, the NAT gateway 638 contained in the data plane VCN 618, and DB subnet(s) 630 contained in the data plane data tier 650. The untrusted app subnet(s) 662 can be communicatively coupled to the service gateway 636 contained in the data plane VCN 618 and DB subnet(s) 630 contained in the data plane data tier 650. The data plane data tier 650 can include DB subnet(s) 630 that can be communicatively coupled to the service gateway 636 contained in the data plane VCN 618.

The untrusted app subnet(s) 662 can include one or more primary VNICs 664(1)-(N) that can be communicatively coupled to tenant virtual machines (VMs) 666(1)-(N). Each tenant VM 666(1)-(N) can be communicatively coupled to a respective app subnet 667(1)-(N) that can be contained in respective container egress VCNs 668(1)-(N) that can be contained in respective customer tenancies 670(1)-(N). Respective secondary VNICs 672(1)-(N) can facilitate communication between the untrusted app subnet(s) 662 contained in the data plane VCN 618 and the app subnet contained in the container egress VCNs 668(1)-(N). Each container egress VCNs 668(1)-(N) can include a NAT gateway 638 that can be communicatively coupled to public Internet 654 (e.g., public Internet 454 of FIG. 4).

The Internet gateway 634 contained in the control plane VCN 616 and contained in the data plane VCN 618 can be communicatively coupled to a metadata management service 652 (e.g., the metadata management system 452 of FIG. 4) that can be communicatively coupled to public Internet 654. Public Internet 654 can be communicatively coupled to the NAT gateway 638 contained in the control plane VCN 616 and contained in the data plane VCN 618. The service gateway 636 contained in the control plane VCN 616 and contained in the data plane VCN 618 can be communicatively coupled to cloud services 656.

In some embodiments, the data plane VCN 618 can be integrated with customer tenancies 670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 646. Code to run the function may be executed in the VMs 666(1)-(N), and the code may not be configured to run anywhere else on the data plane VCN 618. Each VM 666(1)-(N) may be connected to one customer tenancy 670. Respective containers 671(1)-(N) contained in the VMs 666(1)-(N) may be configured to run the code. In this case, there can be a dual isolation (e.g., the containers 671(1)-(N) running code, where the containers 671(1)-(N) may be contained in at least the VM 666(1)-(N) that are contained in the untrusted app subnet(s) 662), which may help prevent incorrect or otherwise undesirable code from damaging the network of the IaaS provider or from damaging a network of a different customer. The containers 671(1)-(N) may be communicatively coupled to the customer tenancy 670 and may be configured to transmit or receive data from the customer tenancy 670. The containers 671(1)-(N) may not be configured to transmit or receive data from any other entity in the data plane VCN 618. Upon completion of running the code, the IaaS provider may kill or otherwise dispose of the containers 671(1)-(N).

In some embodiments, the trusted app subnet(s) 660 may run code that may be owned or operated by the IaaS provider. In this embodiment, the trusted app subnet(s) 660 may be communicatively coupled to the DB subnet(s) 630 and be configured to execute CRUD operations in the DB subnet(s) 630. The untrusted app subnet(s) 662 may be communicatively coupled to the DB subnet(s) 630, but in this embodiment, the untrusted app subnet(s) may be configured to execute read operations in the DB subnet(s) 630. The containers 671(1)-(N) that can be contained in the VM 666(1)-(N) of each customer and that may run code from the customer may not be communicatively coupled with the DB subnet(s) 630.

In other embodiments, the control plane VCN 616 and the data plane VCN 618 may not be directly communicatively coupled. In this embodiment, there may be no direct communication between the control plane VCN 616 and the data plane VCN 618. However, communication can occur indirectly through at least one method. An LPG 610 may be established by the IaaS provider that can facilitate communication between the control plane VCN 616 and the data plane VCN 618. In another example, the control plane VCN 616 or the data plane VCN 618 can make a call to cloud services 656 via the service gateway 636. For example, a call to cloud services 656 from the control plane VCN 616 can include a request for a service that can communicate with the data plane VCN 618.

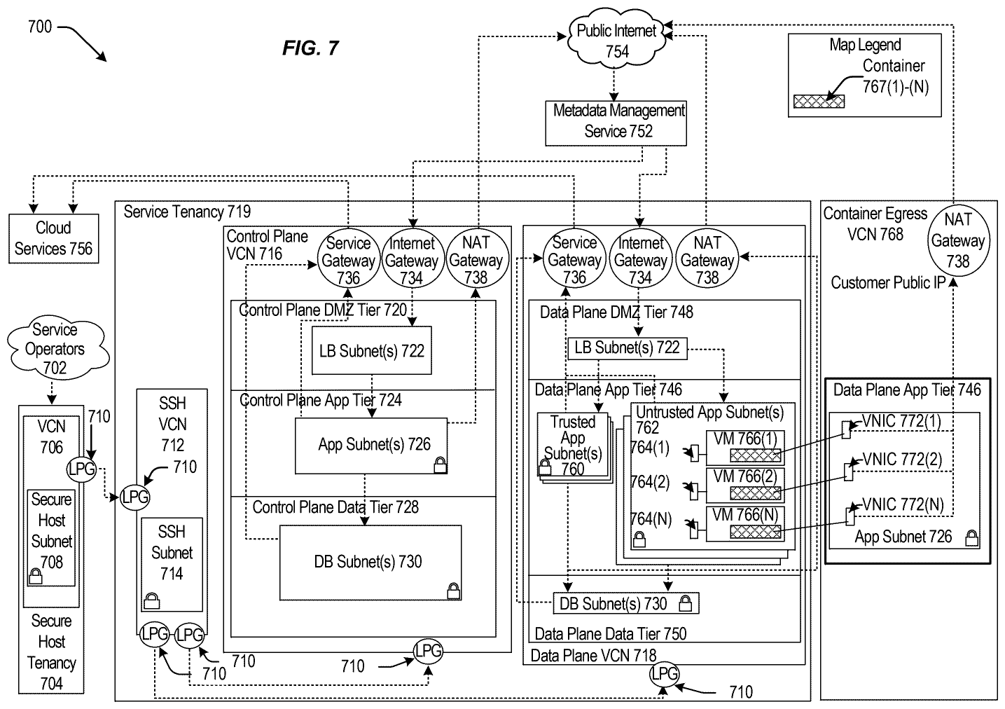

FIG. 7 is a block diagram 700 illustrating another example pattern of an IaaS architecture, according to at least one embodiment. Service operators 702 (e.g., service operators 402 of FIG. 4) can be communicatively coupled to a secure host tenancy 704 (e.g., the secure host tenancy 404 of FIG. 4) that can include a virtual cloud network (VCN) 706 (e.g., the VCN 406 of FIG. 4) and a secure host subnet 708 (e.g., the secure host subnet 408 of FIG. 4). The VCN 706 can include an LPG 710 (e.g., the LPG 410 of FIG. 4) that can be communicatively coupled to an SSH VCN 712 (e.g., the SSH VCN 412 of FIG. 4) via an LPG 710 contained in the SSH VCN 712. The SSH VCN 712 can include an SSH subnet 714 (e.g., the SSH subnet 414 of FIG. 4), and the SSH VCN 712 can be communicatively coupled to a control plane VCN 716 (e.g., the control plane VCN 416 of FIG. 4) via an LPG 710 contained in the control plane VCN 716 and to a data plane VCN 718 (e.g., the data plane 418 of FIG. 4) via an LPG 710 contained in the data plane VCN 718. The control plane VCN 716 and the data plane VCN 718 can be contained in a service tenancy 719 (e.g., the service tenancy 419 of FIG. 4).

The control plane VCN 716 can include a control plane DMZ tier 720 (e.g., the control plane DMZ tier 420 of FIG. 4) that can include LB subnet(s) 722 (e.g., LB subnet(s) 422 of FIG. 4), a control plane app tier 724 (e.g., the control plane app tier 424 of FIG. 4) that can include app subnet(s) 726 (e.g., app subnet(s) 426 of FIG. 4), a control plane data tier 728 (e.g., the control plane data tier 428 of FIG. 4) that can include DB subnet(s) 730 (e.g., DB subnet(s) 630 of FIG. 6). The LB subnet(s) 722 contained in the control plane DMZ tier 720 can be communicatively coupled to the app subnet(s) 726 contained in the control plane app tier 724 and to an Internet gateway 734 (e.g., the Internet gateway 434 of FIG. 4) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 4) and a network address translation (NAT) gateway 738 (e.g., the NAT gateway 438 of FIG. 4). The control plane VCN 716 can include the service gateway 736 and the NAT gateway 738.

The data plane VCN 718 can include a data plane app tier 746 (e.g., the data plane app tier 446 of FIG. 4), a data plane DMZ tier 748 (e.g., the data plane DMZ tier 448 of FIG. 4), and a data plane data tier 750 (e.g., the data plane data tier 450 of FIG. 4). The data plane DMZ tier 748 can include LB subnet(s) 722 that can be communicatively coupled to trusted app subnet(s) 760 (e.g., trusted app subnet(s) 660 of FIG. 6) and untrusted app subnet(s) 762 (e.g., untrusted app subnet(s) 662 of FIG. 6) of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include primary VNICs 764(1)-(N) that can be communicatively coupled to tenant virtual machines (VMs) 766(1)-(N) residing within the untrusted app subnet(s) 762. Each tenant VM 766(1)-(N) can run code in a respective container 767(1)-(N), and be communicatively coupled to an app subnet 726 that can be contained in a data plane app tier 746 that can be contained in a container egress VCN 768. Respective secondary VNICs 772(1)-(N) can facilitate communication between the untrusted app subnet(s) 762 contained in the data plane VCN 718 and the app subnet contained in the container egress VCN 768. The container egress VCN can include a NAT gateway 738 that can be communicatively coupled to public Internet 754 (e.g., public Internet 454 of FIG. 4).

The Internet gateway 734 contained in the control plane VCN 716 and contained in the data plane VCN 718 can be communicatively coupled to a metadata management service 752 (e.g., the metadata management system 452 of FIG. 4) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some examples, the pattern illustrated by the architecture of block diagram 700 of FIG. 7 may be considered an exception to the pattern illustrated by the architecture of block diagram 600 of FIG. 6 and may be desirable for a customer of the IaaS provider if the IaaS provider cannot directly communicate with the customer (e.g., a disconnected region). The respective containers 767(1)-(N) that are contained in the VMs 766(1)-(N) for each customer can be accessed in real-time by the customer. The containers 767(1)-(N) may be configured to make calls to respective secondary VNICs 772(1)-(N) contained in app subnet(s) 726 of the data plane app tier 746 that can be contained in the container egress VCN 768. The secondary VNICs 772(1)-(N) can transmit the calls to the NAT gateway 738 that may transmit the calls to public Internet 754. In this example, the containers 767(1)-(N) that can be accessed in real-time by the customer can be isolated from the control plane VCN 716 and can be isolated from other entities contained in the data plane VCN 718. The containers 767(1)-(N) may also be isolated from resources from other customers.

In other examples, the customer can use the containers 767(1)-(N) to call cloud services 756. In this example, the customer may run code in the containers 767(1)-(N) that requests a service from cloud services 756. The containers 767(1)-(N) can transmit this request to the secondary VNICs 772(1)-(N) that can transmit the request to the NAT gateway that can transmit the request to public Internet 754. Public Internet 754 can transmit the request to LB subnet(s) 722 contained in the control plane VCN 716 via the Internet gateway 734. In response to determining the request is valid, the LB subnet(s) can transmit the request to app subnet(s) 726 that can transmit the request to cloud services 756 via the service gateway 736.

It should be appreciated that IaaS architectures 400, 500, 600, 700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

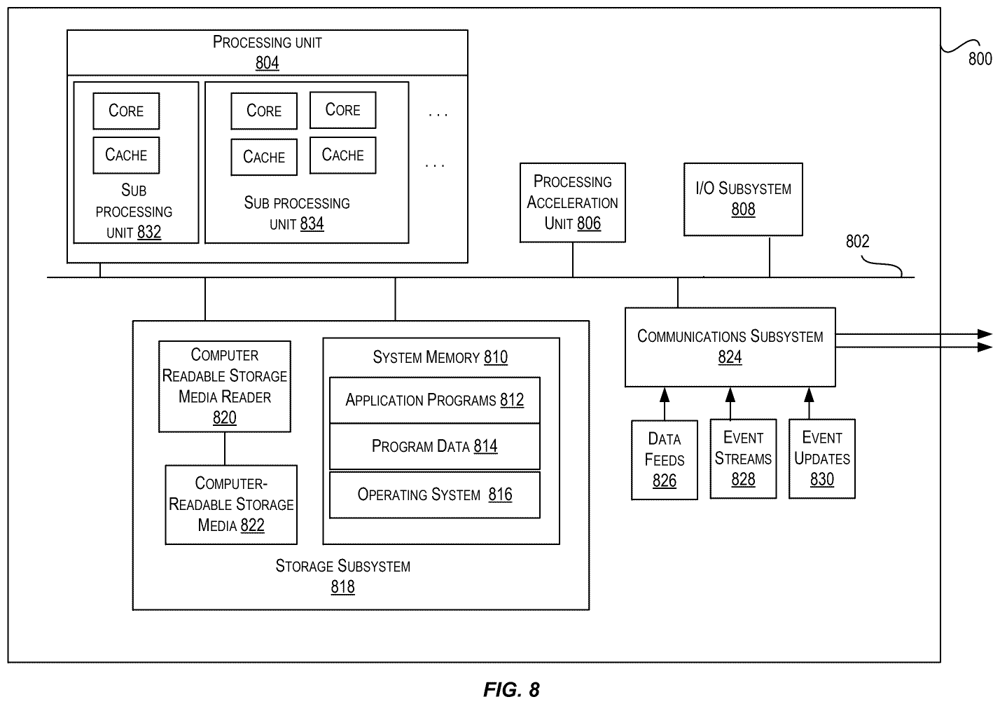

FIG. 8 illustrates an example computer system 800, in which various embodiments may be implemented. The system 800 may be used to implement any of the computer systems described above. As shown in the figure, computer system 800 includes a processing unit 804 that communicates with a number of peripheral subsystems via a bus subsystem 802. These peripheral subsystems may include a processing acceleration unit 806, an I/O subsystem 808, a storage subsystem 818 and a communications subsystem 824. Storage subsystem 818 includes tangible computer-readable storage media 822 and a system memory 810.

Bus subsystem 802 provides a mechanism for letting the various components and subsystems of computer system 800 communicate with each other as intended. Although bus subsystem 802 is shown schematically as a single bus, alternative embodiments of the bus subsystem may utilize multiple buses. Bus subsystem 802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 804, which can be implemented as one or more integrated circuits (e.g., a conventional microprocessor or microcontroller), controls the operation of computer system 800. One or more processors may be included in processing unit 804. These processors may include single core or multicore processors. In certain embodiments, processing unit 804 may be implemented as one or more independent processing units 832 and/or 834 with single or multicore processors included in each processing unit. In other embodiments, processing unit 804 may also be implemented as a quad-core processing unit formed by integrating two dual-core processors into a single chip.

In various embodiments, processing unit 804 can execute a variety of programs in response to program code and can maintain multiple concurrently executing programs or processes. At any given time, some or all of the program code to be executed can be resident in processor(s) 804 and/or in storage subsystem 818. Through suitable programming, processor(s) 804 can provide various functionalities described above. Computer system 800 may additionally include a processing acceleration unit 806, which can include a digital signal processor (DSP), a special-purpose processor, and/or the like.

I/O subsystem 808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 800 may comprise a storage subsystem 818 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 804 provide the functionality described above. Storage subsystem 818 may also provide a repository for storing data used in accordance with the present disclosure.

As depicted in the example in FIG. 8, storage subsystem 818 can include various components including a system memory 810, computer-readable storage media 822, and a computer readable storage media reader 820. System memory 810 may store program instructions that are loadable and executable by processing unit 804. System memory 810 may also store data that is used during the execution of the instructions and/or data that is generated during the execution of the program instructions. Various different kinds of programs may be loaded into system memory 810 including but not limited to client applications, Web browsers, mid-tier applications, relational database management systems (RDBMS), virtual machines, containers, etc.

System memory 810 may also store an operating system 816. Examples of operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 800 executes one or more virtual machines, the virtual machines along with their guest operating systems (GOSs) may be loaded into system memory 810 and executed by one or more processors or cores of processing unit 804.

System memory 810 can come in different configurations depending upon the type of computer system 800. For example, system memory 810 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 810 may include a basic input/output system (BIOS) containing basic routines that help to transfer information between elements within computer system 800, such as during start-up.

Computer-readable storage media 822 may represent remote, local, fixed, and/or removable storage devices plus storage media for temporarily and/or more permanently containing, storing, computer-readable information for use by computer system 800 including instructions executable by processing unit 804 of computer system 800.

Computer-readable storage media 822 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 800.

Machine-readable instructions executable by one or more processors or cores of processing unit 804 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 824 provides an interface to other computer systems and networks. Communications subsystem 824 serves as an interface for receiving data from and transmitting data to other systems from computer system 800. For example, communications subsystem 824 may enable computer system 800 to connect to one or more devices via the Internet. In some embodiments communications subsystem 824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 824 can provide wired network connectivity (e.g., Ethernet) in addition to or instead of a wireless interface.

In some embodiments, communications subsystem 824 may also receive input communication in the form of structured and/or unstructured data feeds 826, event streams 828, event updates 830, and the like on behalf of one or more users who may use computer system 800.

By way of example, communications subsystem 824 may be configured to receive data feeds 826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 824 may also be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to output the structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a computing system, a first series of frames of image data comprising a representation of a vehicle;
for each frame of the first series of frames of the image data:
identifying, by the computing system, a wheel based at least in part on at least a portion of the frame of the image data; and
determining, by the computing system, a set of coordinates indicating a position of the wheel within the frame of the image data;
generating, by the computing system, a graph based at least in part on the set of coordinates indicating the position of each wheel identified in each frame of the first series of frames of the image data;
determining, by the computing system, whether the wheel is associated with the vehicle; and
generating, by the computing system, an axle count of the vehicle.

2. The method of claim 1, further comprising:
receiving, by the computing system, a second series of frames of image data comprising a representation of a portion of the vehicle;
determining, by the computing system, that the portion of the vehicle represented in the second series of frames is associated with the vehicle; and
associating, by the computing system, the portion of the vehicle with the vehicle represented in the first series of frames.

3. The method of claim 1, further comprising:
generating, by the computing system, a bounding box about a portion of each frame of the first series of frames;
identifying, by the computing system, a plurality of wheels in each of the first series of frames of image data;
determining, by the computing system, a first subset of the plurality of wheels comprising one or more wheels inside the bounding box and a second subset of the plurality of wheels outside the bounding box; and
retaining, by the computing system, the first subset of the plurality of wheels for further processing.

4. The method of claim 3, wherein a second subset of the plurality of wheels is identified outside of the bounding box and is excluded from further processing based at least in part on a position of each of the second subset of the plurality of wheels.

5. The method of claim 1, wherein the computing system determines the vehicle is within a region of interest.

6. The method of claim 1, wherein the data indicating the axle count is used to verify a historical axle count associated with the vehicle.

7. The method of claim 1, wherein the wheel is identified using a machine learning model trained exclusively on wheel data.

8. The method of claim 1, further comprising:
providing, by the computing system, at least a portion of the first series of frames to a machine learning model;
determining, by the computing system and using the machine learning model, a bounding box about the vehicle;
determining, by the computing system and using the machine learning model, a vehicle-type of the vehicle and a confidence score associated with the vehicle type; and
determining, by the computing system, the axle count of the vehicle based at least in part on the vehicle-type of the vehicle.

9. A system, comprising:
one or more processors; and
a non-transitory computer readable medium comprising instructions that, when executed by the one or more processors, cause the system to perform operations to:
receive a first series of frames of image data comprising a representation of a vehicle;
for each frame of the first series of frames of the image data:
identify a wheel based at least in part on at least a portion of the frame of image data; and
determine a set of coordinates indicating a position of the wheel within the frame of image data;
generate a graph based at least in part on the set of coordinates indicating the position of each wheel identified in each frame of the first series of frames of image data;
determine whether the wheel is associated with the vehicle, based at least in part on the graph; and
based at least in part on determining that the wheel is associated with the vehicle:
generate an axle count of the vehicle.

10. The system of claim 9, further comprising:
a first detector comprising a first machine learning model configured to identify the vehicle in the first series of frames of image data, determine a vehicle-type of the vehicle, and a confidence score associated with the vehicle-type;
a second detector comprising a second machine learning model configured to identify the wheel within a bounding box generated within the first series of frame of image data; and
a post-processing module configured to generate the axle count of the vehicle based at least in part on the wheel identified within the bounding box.

11. The system of claim 10, wherein a subset of the wheels identified in each frame identified outside of the bounding box and is excluded from further processing based at least in part on a position of each of the second subset of the plurality of wheels.

12. The system of claim 9, wherein the system determines the vehicle is within a region of interest.

13. The system of claim 9, wherein the data indicating the axle count is used to verify a historical axle count associated with the vehicle.

14. The system of claim 9, wherein the wheel is identified using a machine learning model trained exclusively on wheel data.

15. A non-transitory computer readable-medium comprising instructions that, when executed by one or more processors, cause the one or more processors to perform operations comprising:
receiving, by a computing system, a first series of frames of image data comprising a representation of a vehicle;
for each frame of the first series of frames of the image data:
identifying, by the computing system, a wheel based at least in part on at least a portion of the frame of image data; and
determining, by the computing system, a set of coordinates indicating a position of the wheel within the frame of image data;
generating, by the computing system, a graph based at least in part on the set of coordinates indicating the position of each wheel identified in each frame of the first series of frames of image data;
determining, by the computing system, whether the wheel is associated with the vehicle, based at least in part on the graph; and
based at least in part on determining that the wheel is associated with the vehicle:
generating, by the computing system, an axle count of the vehicle; and
storing, by the computing system, the axle count of the vehicle.

16. The non-transitory computer readable-medium claim 15, the operations further comprising:
receiving, by the computing system, a second series of frames of image data comprising a representation of a portion of the vehicle;
determining, by the computing system, that the portion of the vehicle represented in the second series of frames is associated with the vehicle; and
associating, by the computing system, the portion of the vehicle with the vehicle represented in the first series of frames.

17. The non-transitory computer readable-medium claim 15, the operations further comprising:
generating, by the computing system, a bounding box about a portion of each frame of the first series of frames;
identifying, by the computing system, a plurality of wheels in each of the first series of frames of image data;
determining, by the computing system, a first subset of the plurality of wheels comprising one or more wheels inside the bounding box and a second subset of the plurality of wheels outside the bounding box; and
retaining, by the computing system, the first subset of the plurality of wheels for further processing.

18. The non-transitory computer readable-medium claim 15, wherein a subset of the wheels identified in each frame identified outside of the bounding box and is excluded from further processing based at least in part on a position of each of the second subset of the plurality of wheels.

19. The non-transitory computer readable-medium claim 15, wherein the computing system determines the vehicle is within a region of interest.

20. The non-transitory computer readable-medium claim 15, wherein the axle count is used to verify a historical axle count associated with the vehicle.
